(19) United States
(12) Patent Application Publication
(10) Pub. No.: US 2025/0118891 A1
(43) Pub. Date: Apr. 10, 2025

(54) SYSTEMS AND METHODS FOR DISTRIBUTING RADIOHEADS

(71) Applicant: Rearden, LLC, Mountain View, CA (US)

(72) Inventors: Stephen G. Perlman, Palo Alto, CA (US); Roger van der Laan, Lakeport, CA (US); Fadi Saibi, Sunnyvale, CA (US); Mario Di Dio, Longmont, CA (US); Allan Ievers, San Carlos, CO (US); Benyavut Jirasutayasuntorn, Dublin, CA (US); Lynne Freeman, Sacramento, CA (US); Antonio Forenza, San Francisco, CA (US)

(21) Appl. No.: 18/981,039

(22) Filed: Dec. 13, 2024

Related U.S. Application Data
(63) Continuation of application No. 17/532,967, filed on Nov. 22, 2021, now Pat. No. 12,170,401.
Application No. 17/532,967 is a continuation of application No. 15/792,610, filed on Oct. 24, 2017, now Pat. No. 11,189,917.
Application No. 15/792,610 is a continuation-in-part of application No. 15/682,076, filed on Aug. 21, 2017, now Pat. No. 11,050,468.
Application No. 15/682,076 is a continuation-in-part of application No. 14/672,014, filed on Mar. 27, 2015, now Pat. No. 11,190,947.
(60) Provisional application No. 62/413,944, filed on Oct. 27, 2016.
(60) Provisional application No. 62/380,126, filed on Aug. 26, 2016.
(60) Provisional application No. 61/980,479, filed on Apr. 16, 2014.

(51) Int. Cl. H01Q 1/46; H04B 1/38; H04B 1/40

(52) U.S. Cl. CPC H01Q 1/46; H04B 1/38; H04B 1/40

(57) ABSTRACT

Systems and methods are described to create radio daisy chains for convenient and aesthetically pleasing high-density radio deployments.

### CROSS REFERENCE TO RELATED APPLICATIONS

This application is a continuation of U.S. application Ser. No. 17/532,967, filed on Nov. 22, 2021, which is a continuation of U.S. application Ser. No. 15/792,610, filed Oct. 24, 2017, which claims the benefit of U.S. Provisional Application No. 62/413,944, filed Oct. 27, 2016, entitled, “System and Methods For Distributing Radioheads”.

U.S. application Ser. No. 17/532,967 is a continuation-in-part of U.S. application Ser. No. 15/682,076, filed Aug. 21, 2017, entitled “Systems And Methods For Mitigating Interference Within Actively Used Spectrum”, which claims the benefit of and priority to U.S. Provisional Application No. 62/380,126, filed Aug. 26, 2016, entitled “Systems and Methods for Mitigating Interference within Actively Used Spectrum” and U.S. application Ser. No. 15/682,076, filed Aug. 21, 2017, is also a continuation-in-part of U.S. application Ser. No. 14/672,014, filed Mar. 27, 2015, entitled “Systems and Methods for Concurrent Spectrum Usage Within Actively Used Spectrum” which claims the benefit of and priority to U.S. Provisional Patent Application No. 61/980,479, filed Apr. 16, 2014, entitled, “Systems and Methods for Concurrent Spectrum Usage Within Actively Used Spectrum”.

This application may be related to the following co-pending U.S. patent applications and U.S. Provisional Applications:
U.S. Provisional Application Ser. No. 62/380,126, entitled “Systems and Methods for Mitigating Interference within Actively Used Spectrum”
U.S. application Ser. No. 14/611,565, entitled “Systems and Methods for Mapping Virtual Radio Instances into Physical Areas of Coherence in Distributed Antenna Wireless Systems”
U.S. application Ser. No. 14/086,700, entitled “Systems and Methods for Exploiting Inter-cell Multiplexing Gain in Wireless Cellular Systems Via Distributed Input Distributed Output Technology”
U.S. application Ser. No. 13/844,355, entitled “Systems and Methods for Radio Frequency Calibration Exploiting Channel Reciprocity in Distributed Input Distributed Output Wireless Communications”
U.S. application Ser. No. 13/797,984, entitled “Systems and Methods for Exploiting Inter-cell Multiplexing Gain in Wireless Cellular Systems Via Distributed Input Distributed Output Technology”
U.S. application Ser. No. 13/797,971, entitled “Systems and Methods for Exploiting Inter-cell Multiplexing Gain in Wireless Cellular Systems Via Distributed Input Distributed Output Technology”
U.S. application Ser. No. 13/797,950, entitled “Systems and Methods for Exploiting Inter-cell Multiplexing Gain in Wireless Cellular Systems Via Distributed Input Distributed Output Technology”
U.S. application Ser. No. 13/233,006, entitled “System and Methods for planned evolution and obsolescence of multiuser spectrum”
U.S. application Ser. No. 13/232,996, entitled “Systems and Methods to Exploit Areas of Coherence in Wireless Systems”
U.S. application Ser. No. 12/802,989, entitled “System And Method For Managing Handoff Of A Client Between Different Distributed-Input-Distributed-Output (DIDO) Networks Based On Detected Velocity Of The Client”
U.S. application Ser. No. 12/802,988, entitled “Interference Management, Handoff, Power Control And Link Adaptation In Distributed-Input Distributed-Output (DIDO) Communication Systems”
U.S. application Ser. No. 12/802,975, entitled “System And Method For Link adaptation In DIDO Multicarrier Systems”
U.S. application Ser. No. 12/802,974, entitled “System And Method For Managing Inter-Cluster Handoff Of Clients Which Traverse Multiple DIDO Clusters”
U.S. application Ser. No. 12/802,958, entitled “System And Method For Power Control And Antenna Grouping In A Distributed-Input-Distributed-Output (DIDO) Network”
U.S. Pat. No. 9,685,997, entitled “Systems and Methods to enhance spatial diversity in distributed-input distributed-output wireless systems”
U.S. Pat. No. 9,386,465, issued Jul. 5, 2016 entitled “System and Method For Distributed Antenna Wireless Communications”
U.S. Pat. No. 9,369,888, issued Jun. 14, 2016 entitled “Systems And Methods To Coordinate Transmissions In Distributed Wireless Systems Via User Clustering”
U.S. Pat. No. 9,312,929, issued Apr. 12, 2016, entitled “System and Methods to Compensate for Doppler Effects in Distributed-Input Distributed Output Systems”
U.S. Pat. No. 8,989,155, issued Mar. 24, 2015, entitled “Systems and Methods for Wireless Backhaul in Distributed-Input Distributed-Output Wireless Systems”
U.S. Pat. No. 8,971,380, issued Mar. 3, 2015, entitled “System and Method for Adjusting DIDO Interference Cancellation Based On Signal Strength Measurements
U.S. Pat. No. 8,654,815, issued Feb. 18, 2014, entitled “System and Method for Distributed Input Distributed Output Wireless Communications”
U.S. Pat. No. 8,571,086, issued Oct. 29, 2013, entitled “System and Method for DIDO Precoding Interpolation in Multicarrier Systems”
U.S. Pat. No. 8,542,763, issued Sep. 24, 2013, entitled “Systems and Methods To Coordinate Transmissions In Distributed Wireless Systems Via User Clustering”
U.S. Pat. No. 8,428,162, issued Apr. 23, 2013, entitled “System and Method for Distributed Input Distributed Output Wireless Communications”
U.S. Pat. No. 8,170,081, issued May 1, 2012, entitled “System And Method For Adjusting DIDO Interference Cancellation Based On Signal Strength Measurements”
U.S. Pat. No. 8,160,121, issued Apr. 17, 2012, entitled, “System and Method For Distributed Input-Distributed Output Wireless Communications”;
U.S. Pat. No. 7,885,354, issued Feb. 8, 2011, entitled “System and Method For Enhancing Near Vertical Incidence Skywave (“NVIS”) Communication Using Space-Time Coding.”
U.S. Pat. No. 7,711,030, issued May 4, 2010, entitled “System and Method For Spatial-Multiplexed Tropospheric Scatter Communications”;
U.S. Pat. No. 7,636,381, issued Dec. 22, 2009, entitled “System and Method for Distributed Input Distributed Output Wireless Communication”;
U.S. Pat. No. 7,633,994, issued Dec. 15, 2009, entitled “System and Method for Distributed Input Distributed Output Wireless Communication”;
U.S. Pat. No. 7,599,420, issued Oct. 6, 2009, entitled “System and Method for Distributed Input Distributed Output Wireless Communication”;
U.S. Pat. No. 7,418,053, issued Aug. 26, 2008, entitled “System and Method for Distributed Input Distributed Output Wireless Communication”.

### BACKGROUND

As wireless communications systems steadily grow in density, placement of radios becomes increasingly difficult. There are challenges in finding physical locations to hold radios, challenges in bringing backhaul and/or fronthaul (“fronthaul”, as used herein, refers to a communications infrastructure that carries the radio signal in some form to a radiohead, as opposed to “backhaul”, as used herein, which carries user data to the base stations which generate the radio waveform to carry the user data). With conventional cellular systems (e.g. LTE, UMTS) or conventional interference avoidance systems (e.g. Wi-Fi), to optimize performance and frequency reuse, base station or antenna planning requires placing radios in certain locations for coverage, and avoiding other locations to mitigate interference. Then, even assuming the technical issues can be overcome, there are local and national government restrictions on radio and antenna placement, for example, out of concern for the visual appearance of the radios and antennas. Even if radios or antennas meet standards for government approval, the permitting process may be very slow, sometimes taking years to have antenna deployments approved.

Throughout the history of radio communications, there have been a vast number of different approaches to deploying radios and antennas, depending on the type of radio technology (e.g. satellite, mobile, television, etc.), the frequencies of the transmissions (e.g. HF, VHF, UHF, microwave, millimeter wave, etc.), and the directionality of the transmission (e.g. omnidirectional, high gain, or narrow beam, etc.). Also, aesthetic considerations have often come into play, from simple efforts like painting radios and antennas to match their surroundings, to elaborate efforts like fashioning cellular towers to look like palm trees.

Because achieving optimal performance in conventional cellular and interference-avoiding networks requires radios and antennas to be placed according to a specific plan (e.g. not too far apart such that coverage is lost, and not too close together to avoid intercell interference), these requirements often clash with other constraints, such as the availability of mounting solutions at the sites and backhaul and/or fronthaul. And, in many situations (e.g. a historic building) no radio or antenna solution is acceptable because the government will not permit anything mounted on or near the building that changes the appearance of the building.

Radios and antennas have been placed on towers, rooftops, utility poles, on power lines and strung between utility poles. Radios and antennas have been placed at indoor locations in ceilings, on walls, on shelves, on tabletops, etc. Radios have also been placed inside stadiums on their structural elements, under seats, etc. Specialized antennas such as “leaky feeders” (described below) have been placed in tunnels. In short, radios and antennas have been placed in any location imaginable.

Examples of prior art efforts to attach radios and antennas to power lines, include those disclosed in U.S. Pat. Nos. 7,862,837, 8,780,901 and US 2014/0286444, and prior art efforts to attaching radios and antennas to utility poles include those of the Metricom Ricochet packet communication network, for example, as disclosed in U.S. Pat. No. 7,068,630.

A utility pole 400 or 401 such as illustrated prior art FIG. 4 is often divided into two zones, a typically higher zone, which may be called the “supply space” where electrical power lines are carried on cables, such as in the area of crossarm 403. A typically lower zone, where it is safe for workers to attach communications cables and equipment may be called the “communications space”, with communications cables and equipment illustrated in this zone in prior art FIG. 5, at the height of crossarm 402.

Some prior art systems place the radios and/or antennas in the supply zone on the utility poles, as shown in FIG. 4 with radios and/or antennas 410 and 411, and/or place radios and/or antennas on the power lines themselves as shown with radios and/or antennas 420 and 421.

Some prior art systems place the radios and/or antennas in the communications zone on the utility poles, as shown in FIG. 5 with radios and/or antennas 550 and 551, and/or place radios and/or antennas on cables (often communications cables) strung between utility poles as shown with radios and/or antennas 540 and 541. Backhaul or fronthaul may be carried on communications cables 531, which typically are electrical (e.g. copper) or fiber, are often protected by insulation or an outer duct 530, and often derive structural support from a mechanically strong cable 532, often made of braided steel. Sometimes radios are attached to the pole and/or cabling and then they are coupled to antennas that are either on the pole or the cabling, or embedded in the radios, as shown in FIG. 5. In some prior art systems, radios derive power from the power lines, often through a step-down power supply 561 and measured by a power meter 560 so that usage cost can be assessed by the electric utility providing power. Radios such as 550 and 551 can also be used for backhaul or fronthaul.

FIG. 6 shows a prior art configuration with antennas and/or radios on lamp posts. Lamp posts, as used herein are utility poles that do not have aerial power or communications cables between them. The antennas 601 and 602 might be coupled to radios 611 and 612, or they may be in the same enclosure with the radio and thus there is no need for a separate radio 611 or 612. The backhaul or fronthaul cabling (e.g. copper or fiber) may be conveyed through an underground conduit 630 (illustrated with dotted lines to indicate the conduit is underground and not visible) or the backhaul or fronthaul can be carried through a wireless link between the lamp posts. If the backhaul or fronthaul is underground, then it is typically conveyed from the underground conduit through the interior of the lamp post (e.g. if it is metal or hollow) or, as illustrated with 621 and 622, through a conduit or duct from the ground up the side of the lamp post, either through a radio 611 and 612, or directly to the top of the lamp post. The approach of using underground conduit for backhaul or fronthaul as illustrated in FIG. 6 for lamp posts can also be applied to the utility poles illustrated in FIGS. 4 and 5, with cabling from underground conduit either conveyed through the interior of the utility pole (e.g. if it is metal and hollow) or through a conduit or duct from the ground up the side of the utility pole.

Backhaul and/or fronthaul (whether to radios on utility poles or radios placed elsewhere) can be provided to radios over a wide range of media, including coax, fiber, line-of-sight wireless, non-line-of-sight wireless, etc. A wide range of protocols can be used over the media, including Ethernet, Common Public Radio Interface (“CPRI”), Multimedia over Coax Alliance (“MoCA”), Data Over Cable Service Interface Specification (“DOCSIS”), Broadband over Power Line (“BPL”), etc.

A wide range of switches, splitters, hubs can be used for distributing wireline (e.g. copper, fiber, etc.) communications. Analog splitters are often used to distribute coaxial connections (e.g. to distribute DOCSIS and/or MoCA data). Electric outlet couplings can be used to distribute BPL. Ethernet switches and hubs are often used to distribute copper and fiber Ethernet connections. Many radios made for home and commercial applications have built-in switches as a convenience to pass-through Ethernet, so that if the radio is plugged into an Ethernet cable, there is another Ethernet jack on the radio that can be used to plug in other devices.

Another prior art technology that has been used for distributing wireless connectivity down a cable is what is called a “leaky feeder” or a “leaky cable”. A leaky feeder is a cable that carries wireless signals, but deliberately leaks and absorbs wireless radiation through the sides of the cable. An exemplary prior art leaky cable 700 is illustrated in FIG. 7. It is very similar to a coaxial cable in that there is an insulating and protective jacket 701, an outer conductor 702 (e.g. copper foil), a dielectric 704 (e.g. dielectric foam), and an inner conductor 705 (e.g. a copper wire). But, unlike a coaxial cable, there are apertures 703 in the outer conductor 702 that allow the wireless radiation to propagate out of and into the leaky feeder 700.

Leaky feeders are often used in tunnels or shafts (e.g. mining tunnels, subway tunnels) where they are attached to the side of the tunnel or shaft to run along the length of the tunnel or shaft. This way, regardless of where a user is located in the tunnel or shaft, the user will have wireless connectivity to a nearby part of the leaky feeder. Because leaky feeders leak wireless energy, they often have radio frequency amplifiers inserted periodically to boost the signal power. If two or more leaky feeders are run together, then prior art MIMO techniques can be used to increase capacity.

Leaky feeder deployment is convenient and fast in that it is like deploying cabling, with just amplifiers deployed periodically between lengths of leaky feeder to repeatedly restore the signal strength.

A fundamental limitation of leaky feeders is that the same channel is shared for the entire length of the leaky feeder cabling. Thus, a user at one end of a leaky feeder shares the channel with a user in the middle of the leaky feeder as well as with a user at the end of the leaky feeder. While this may be acceptable for applications where users are sparsely distributed along the length of the leaky feeder or there is low data capacity demand by users (e.g. for voice communications in a mining tunnel or shaft), it is not suited for applications where there is a high density of users and/or high data capacity demand by users since users throughout the entire length of the leaky feeder will be sharing the same channel, despite the fact they are very far from each other. Thus, while leaky feeders are convenient to deploy, since they are like deploying cabling with periodic amplifiers, to provide coverage their deployment works against densification.

Regardless of what prior techniques are used placing radios and/or antennas and how backhaul or fronthaul is provisioned, as noted, current wireless systems are faced with challenges of densification. There is not a good general-purpose solution for densification that provides highly efficient and reliable coverage and service, is easily and rapidly deployed, and avoids being unsightly and/or subject to government restrictions. The below teachings address these issues.

### BRIEF DESCRIPTION OF THE DRAWINGS

A better understanding of the present invention can be obtained from the following detailed description in conjunction with the drawings, in which:

FIG. 1 illustrates the general framework of a DIDO, now branded pCell™, Radio Access Network (DRAN) and other multi-user multi-antenna system (MU-MAS) networks,

FIGS. 2a and 2b illustrates the protocol stack of a Virtual Radio Instance (VRI) consistent to the OSI model and LTE standard.

FIG. 3 illustrates adjacent DRANs to extend coverage in DIDO, now branded pCell™, wireless networks and other MU-MAS networks.

FIG. 4 is a prior art illustration of utility poles with radios and/or antennas in the “supply space”.

FIG. 5 is a prior art illustration of utility poles with radios and/or antennas in the “communications space”.

FIG. 6 is a prior art illustration of lamp posts with radios and/or antennas.

FIG. 7 is a prior art illustration of a leaky feeder.

FIG. 8a illustrates a coaxial cable embodiment of a radio daisy chain.

FIG. 8b illustrates a twisted pair embodiment of a radio daisy chain.

FIG. 8c illustrates a fiber embodiment of a radio daisy chain.

FIG. 8d illustrates a combined coaxial and twisted pair embodiment of a radio daisy chain.

FIG. 9a illustrates one embodiment of the architecture of a daisy chain radio illustrating the basic architecture.

FIG. 9b illustrates one embodiment of the architecture of a daisy chain radio illustrating timing distribution.

FIG. 9c illustrates one embodiment of the architecture of a daisy chain radio illustrating power distribution.

FIG. 9d illustrates one embodiment of the architecture of a daisy chain radio illustrating RF distribution.

FIG. 9e illustrates one embodiment of the architecture of a daisy chain radio illustrating a daisy chain network implemented through a splitter.

FIG. 10a illustrates one embodiment of a daisy chain radio with a sleeve or duct.

FIG. 10b illustrates one embodiment of a daisy chain radio with a sleeve or duct with one or more pass-through cables.

FIG. 10c illustrates one embodiment of a daisy chain radio with a sleeve or duct with one or more pass-through cables and a support strand.

FIG. 10d illustrates one embodiment of daisy chain radios with sleeves or ducts with one or more pass-through cables and a support strand with data and/or power couplers.

FIG. 11 is an illustration of utility poles with daisy chain radios.

FIG. 12 is an illustration of lamp posts with daisy chain radios.

FIG. 13 is an illustration of a building with daisy chain radios.

FIG. 14 is an illustration of daisy chain radios in non-straight deployment patterns.

FIG. 15 is an illustration of daisy chain radios in an array.

FIG. 16 is an illustration of daisy chain radios in deployed in a Cloud-Radio Access Network.

### DETAILED DESCRIPTION

One solution to overcome many of the above prior art limitations is to daisy-chain network and power cables and small distributed radioheads utilized in a multi-user multi-antenna system (MU-MAS). By making the radioheads extremely small, they can be physically no larger than the cabling, thus making the daisy-chained radio installation similar to a cable installation. Not only is a cable installation often much simpler than antenna or radio installations, but cable deployments often require no government permits, or in most cases they are much easier to gain permit approval than deployments of large antennas or large radio enclosures. Also, in terms of aesthetics, cables can often be partially or completely hidden from sight, whereas it may be more difficult or impractical to hide a conventional radio and/or antenna.

Further, in the below detailed embodiments spectral efficiency can be vastly increased by implementing one or both networks using Distributed-Input Distributed-Output (“DIDO”) technology and other MU-MAS technology as described in the following patents, patent applications and provisional applications, all of which are assigned the assignee of the present patent and are incorporated by reference. These patents, applications and provisional applications are sometimes referred to collectively herein as the “Related patents and applications.”
U.S. Provisional Application Ser. No. 62/380,126, entitled “Systems and Methods for Mitigating Interference within Actively Used Spectrum”.
U.S. Application Provisional No. 62/380,126, entitled “Systems and Methods for Mitigating Interference within Actively Used Spectrum”.
U.S. application Ser. No. 14/672,014, entitled “Systems And Methods For Concurrent Spectrum Usage Within Actively Used Spectrum”.
U.S. Provisional Patent Application No. 61/980,479, filed Apr. 16, 2014, entitled, “Systems and Methods for Concurrent Spectrum Usage Within Actively Used Spectrum”.
U.S. application Ser. No. 14/611,565, entitled “Systems and Methods for Mapping Virtual Radio Instances into Physical Areas of Coherence in Distributed Antenna Wireless Systems”
U.S. application Ser. No. 14/086,700, entitled “Systems and Methods for Exploiting Inter-cell Multiplexing Gain in Wireless Cellular Systems Via Distributed Input Distributed Output Technology”
U.S. application Ser. No. 13/844,355, entitled “Systems and Methods for Radio Frequency Calibration Exploiting Channel Reciprocity in Distributed Input Distributed Output Wireless Communications”
U.S. application Ser. No. 13/797,984, entitled “Systems and Methods for Exploiting Inter-cell Multiplexing Gain in Wireless Cellular Systems Via Distributed Input Distributed Output Technology”
U.S. application Ser. No. 13/797,971, entitled “Systems and Methods for Exploiting Inter-cell Multiplexing Gain in Wireless Cellular Systems Via Distributed Input Distributed Output Technology”
U.S. application Ser. No. 13/797,950, entitled “Systems and Methods for Exploiting Inter-cell Multiplexing Gain in Wireless Cellular Systems Via Distributed Input Distributed Output Technology”
U.S. application Ser. No. 13/233,006, entitled “System and Methods for planned evolution and obsolescence of multiuser spectrum”
U.S. application Ser. No. 13/232,996, entitled “Systems and Methods to Exploit Areas of Coherence in Wireless Systems”
U.S. application Ser. No. 12/802,989, entitled “System And Method For Managing Handoff Of A Client Between Different Distributed-Input-Distributed-Output (DIDO) Networks Based On Detected Velocity Of The Client”
U.S. application Ser. No. 12/802,988, entitled “Interference Management, Handoff, Power Control And Link Adaptation In Distributed-Input Distributed-Output (DIDO) Communication Systems”
U.S. application Ser. No. 12/802,975, entitled “System And Method For Link adaptation In DIDO Multicarrier Systems”
U.S. application Ser. No. 12/802,974, entitled “System And Method For Managing Inter-Cluster Handoff Of Clients Which Traverse Multiple DIDO Clusters”
U.S. application Ser. No. 12/802,958, entitled “System And Method For Power Control And Antenna Grouping In A Distributed-Input-Distributed-Output (DIDO) Network”
U.S. Pat. No. 9,685,997, entitled “Systems and Methods to enhance spatial diversity in distributed-input distributed-output wireless systems”
U.S. Pat. No. 9,386,465, issued Jul. 5, 2016 entitled “System and Method For Distributed Antenna Wireless Communications”
U.S. Pat. No. 9,369,888, issued Jun. 14, 2016 entitled “Systems And Methods To Coordinate Transmissions In Distributed Wireless Systems Via User Clustering”
U.S. Pat. No. 9,312,929, issued Apr. 12, 2016, entitled “System and Methods to Compensate for Doppler Effects in Distributed-Input Distributed Output Systems”
U.S. Pat. No. 8,989,155, issued Mar. 24, 2015, entitled “Systems and Methods for Wireless Backhaul in Distributed-Input Distributed-Output Wireless Systems”
U.S. Pat. No. 8,971,380, issued Mar. 3, 2015, entitled “System and Method for Adjusting DIDO Interference Cancellation Based On Signal Strength Measurements
U.S. Pat. No. 8,654,815, issued Feb. 18, 2014, entitled “System and Method for Distributed Input Distributed Output Wireless Communications”
U.S. Pat. No. 8,571,086, issued Oct. 29, 2013, entitled “System and Method for DIDO Precoding Interpolation in Multicarrier Systems”
U.S. Pat. No. 8,542,763, issued Sep. 24, 2013, entitled “Systems and Methods To Coordinate Transmissions In Distributed Wireless Systems Via User Clustering”
U.S. Pat. No. 8,428,162, issued Apr. 23, 2013, entitled “System and Method for Distributed Input Distributed Output Wireless Communications”
U.S. Pat. No. 8,170,081, issued May 1, 2012, entitled “System And Method For Adjusting DIDO Interference Cancellation Based On Signal Strength Measurements”
U.S. Pat. No. 8,160,121, issued Apr. 17, 2012, entitled, “System and Method For Distributed Input-Distributed Output Wireless Communications”;
U.S. Pat. No. 7,885,354, issued Feb. 8, 2011, entitled “System and Method for Enhancing Near Vertical Incidence Skywave (“NVIS”) Communication Using Space-Time Coding.”
U.S. Pat. No. 7,711,030, issued May 4, 2010, entitled “System and Method For Spatial-Multiplexed Tropospheric Scatter Communications”;
U.S. Pat. No. 7,636,381, issued Dec. 22, 2009, entitled “System and Method for Distributed Input Distributed Output Wireless Communication”;
U.S. Pat. No. 7,633,994, issued Dec. 15, 2009, entitled “System and Method for Distributed Input Distributed Output Wireless Communication”;
U.S. Pat. No. 7,599,420, issued Oct. 6, 2009, entitled “System and Method for Distributed Input Distributed Output Wireless Communication”;
U.S. Pat. No. 7,418,053, issued Aug. 26, 2008, entitled “System and Method for Distributed Input Distributed Output Wireless Communication”.

### 1. Systems and Methods for Distributing Radio Heads

### 1.1 a MU-MAS System Improved by Embodiments of the Present Invention

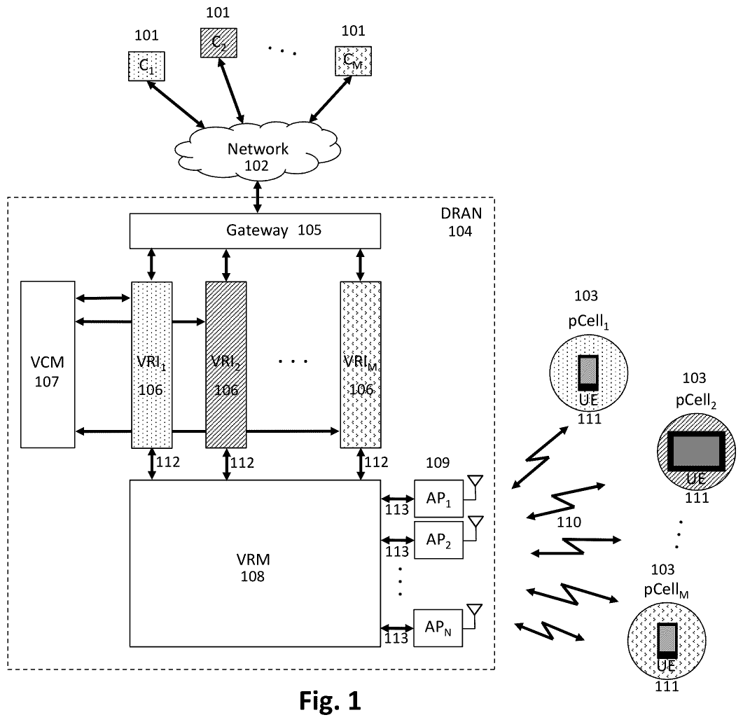

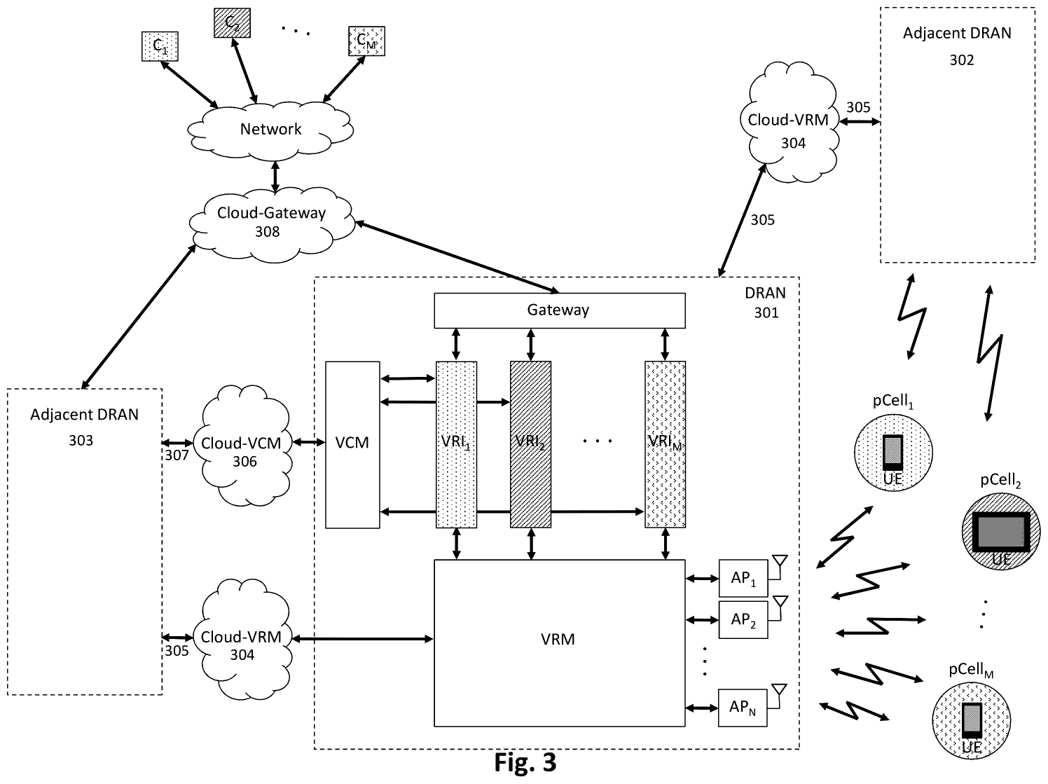

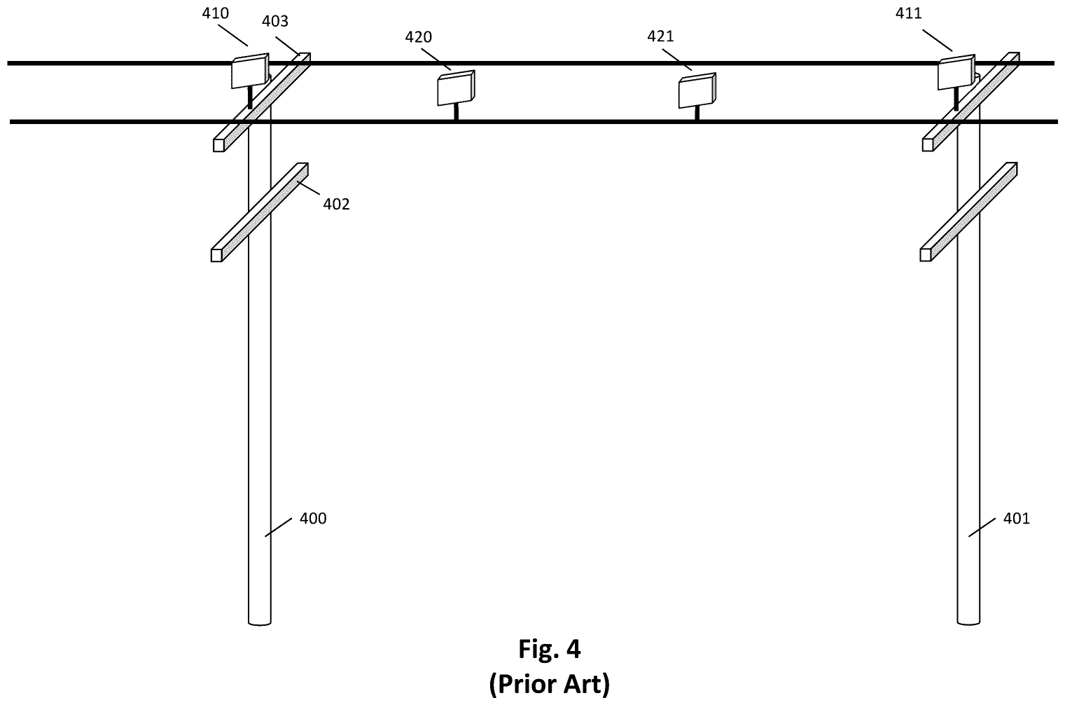

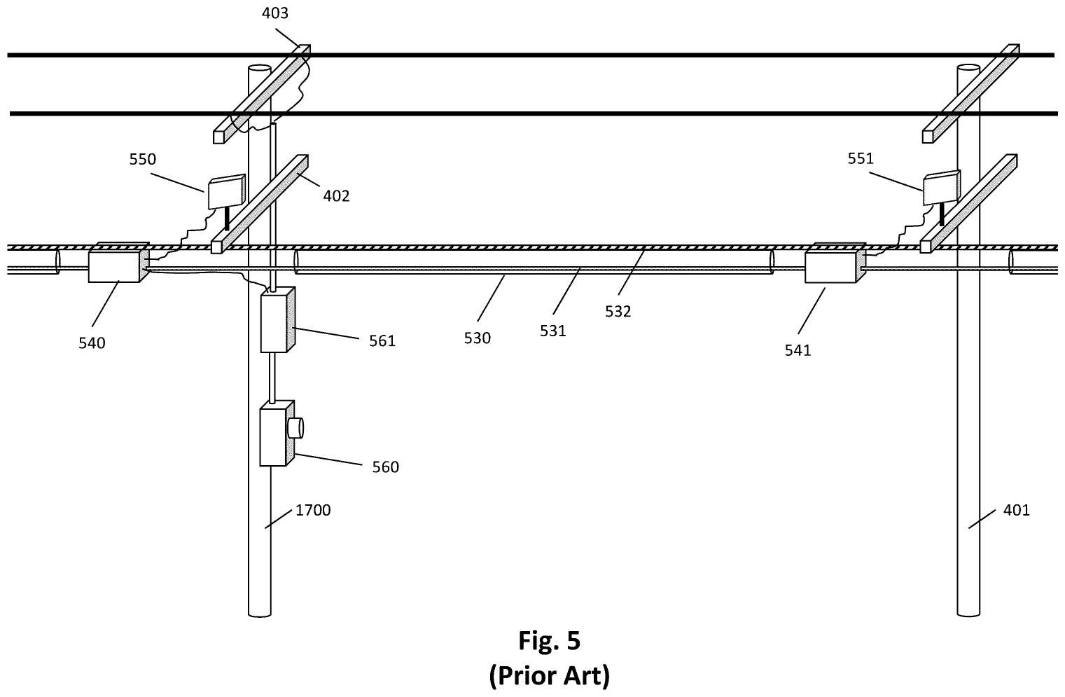

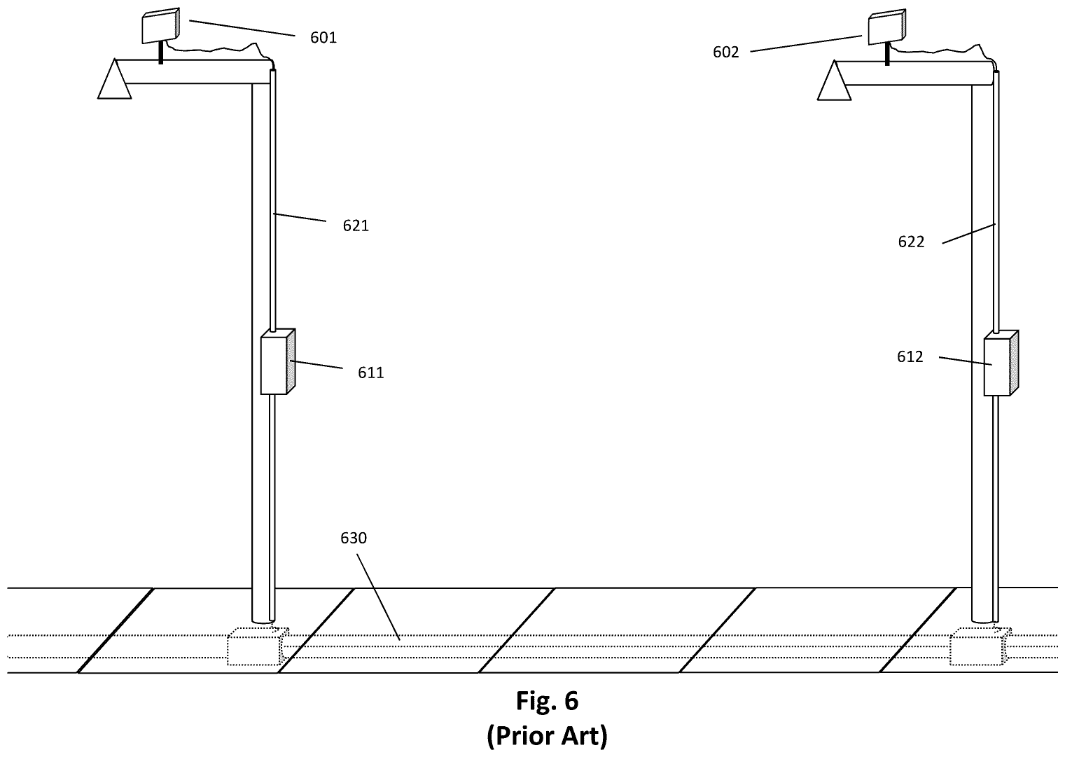

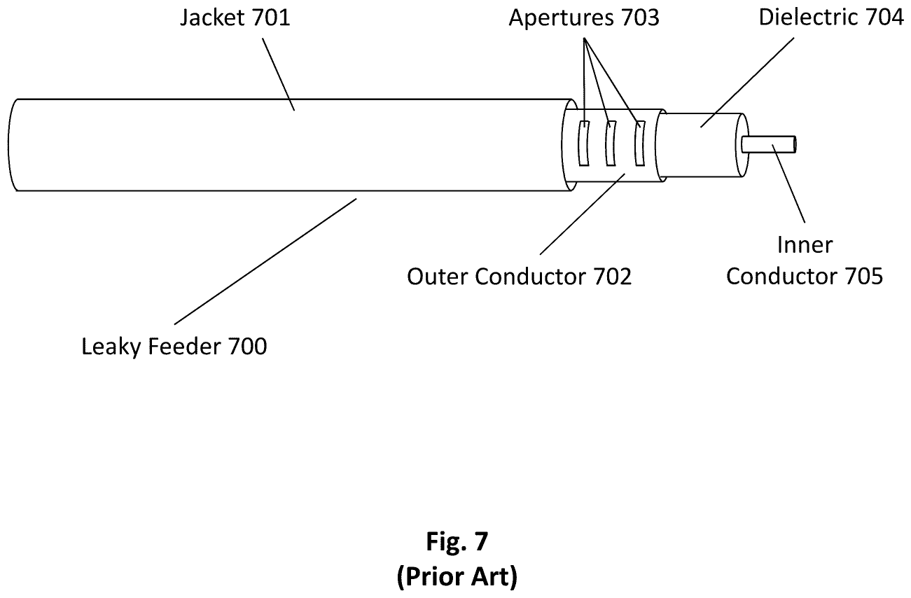

The preferred embodiments of the present invention are improvements to multi-user multi-antenna systems described in co-pending U.S. application Ser. No. 14/611,565, entitled “Systems and Methods for Mapping Virtual Radio Instances into Physical Areas of Coherence in Distributed Antenna Wireless Systems” (of which this application is a continuation-in-part) and other Related patents and applications, as well as in their counterparts filed in other countries. FIGS. 1, 2 and 3 and the following six paragraphs describing them, correspond to FIGS. 1, 2 and 3 and paragraphs [0074-0080] of U.S. application Ser. No. 14/611,565 as its counterparts filed in other countries.

The presently preferred embodiments are systems and methods to improve systems and methods to deliver multiple simultaneous non-interfering data streams within the same frequency band between a network and a plurality of areas of coherence in a wireless link through Virtual Radio Instances (VRIs). In one embodiment the system is a multiuser multiple antenna system (MU-MAS) as depicted in FIG. 1. The color-coded (using patterns instead of colors) units in FIG. 1 show one-to-one mapping between the data sources 101, the VRIs 106 and the areas of coherence 103 as described hereafter.

In FIG. 1, the data sources 101 are data files or streams carrying web content or files in a local or remote server, such as text, images, sounds, videos or combinations of those. One or multiple data files or streams are sent or received between the network 102 and every area of coherence 103 in the wireless link 110. In one embodiment the network is the Internet or any wireline or wireless local area network.

The area of coherence is a volume in space where the waveforms from different antennas of the MU-MAS add up coherently in a way that only the data output 112 of one VRI is received within that area of coherence, without any interference from other data output from other VRIs sent simultaneously over the same wireless link. In the present application we use the term “area of coherence” to describe volumes of coherence or personal cells (e.g., “pCells™” 103) as described in previous patent application [U.S. application Ser. No. 13/232,996, entitled “Systems and Methods to Exploit Areas of Coherence in Wireless Systems”]. In one embodiment, the areas of coherence correspond to the locations of the user equipment (UE) 111 or subscribers of the wireless network, such that every subscriber is associated with one or multiple data sources 101. The areas of coherence may vary in size and shape depending on propagation conditions as well as type of MU-MAS precoding techniques employed to generate them. In one embodiment of the invention, the MU-MAS precoder dynamically adjusts size and shape of the areas of coherence to adapt to the changing propagation conditions while delivering contents to the users with good link reliability.

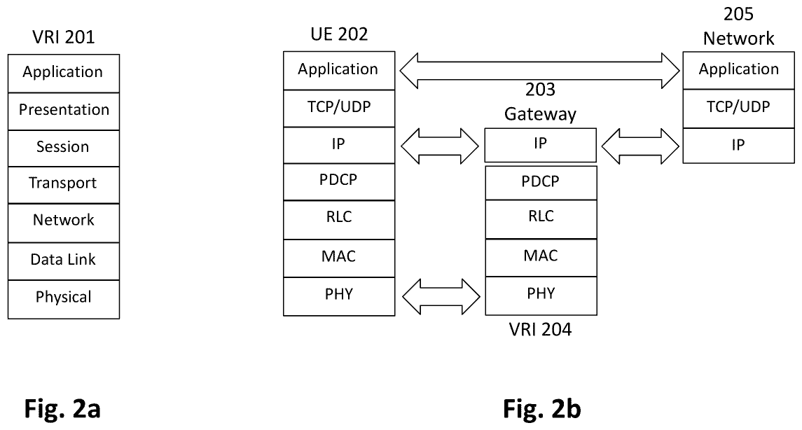

The data sources 101 are first sent through the Network 102 to the DIDO Radio Access Network (DRAN) 104. Then, the DRAN translates the data files or streams into a data format that can be received by the UEs and sends the data files or streams simultaneously to the plurality of areas of coherence, such that every UE receives its own data files or streams without interference from other data files or streams sent to other UEs. The DRAN consists of a gateway 105 as the interface between the network and the VRIs 106. The VRIs translate packets being routed by the gateway into data streams 112, either as raw data, or in a packet or frame structure, that are fed to a MU-MAS baseband unit. In one embodiment, the VRI comprises the open systems interconnection (OSI) protocol stack consisting of several layers: application, presentation, session, transport, network, data link and physical, as depicted in FIG. 2a. In another embodiment, the VRI only comprises a subset of the OSI layers.

In another embodiment, the VRIs are defined from different wireless standards. By way of example, but not limitation, a first VRI consists of the protocol stack from the GSM standard, a second VRI from the 3G standard, a third VRI from HSPA+ standard, a fourth VRI from LTE standard, as fifth VRI from LTE-A standard and a sixth VRI from the Wi-Fi standard. In an exemplary embodiment, the VRIs comprise the control-plane or user-plane protocol stack defined by the LTE standards. The user-plane protocol stack is shown in FIG. 2b. Every UE 202 communicates with its own VRI 204 through the PHY, MAC, RLC and PDCP layers, with the gateway 203 through the IP layer and with the network 205 through the application layer. For the control-plane protocol stack, the UE also communicates directly with the mobility management entity (MME) through the NAS (as defined in the LTE standard stack) layer.

The Virtual Connection Manager (VCM) 107 is responsible for assigning the PHY layer identity of the UEs (e.g., cell-specific radio network temporary identifier, RNTI), authentication and mobility of the VRI and UE. The data streams 112 at the output of the VRIs are fed to the Virtual Radio Manager (VRM) 108. The VRM comprises a scheduler unit (that schedules DL (downlink) and UL (uplink) packets for different UEs), a baseband unit (e.g., comprising of FEC encoder/decoder, modulator/demodulator, resource grid builder) and a MU-MAS baseband processor (comprising of precoding methods). In one embodiment, the data streams 112 are I/Q samples at the output of the PHY layer in FIG. 2b that are processed by the MU-MAS baseband processor. In a different embodiment, the data streams 112 are MAC, RLC or PDCP packets sent to a scheduler unit that forwards them to a baseband unit. The baseband unit converts packets into I/Q fed to the MU-MAS baseband processor.

The MU-MAS baseband processor is the core of the VRM that converts the M I/Q samples from the M VRIs into N data streams 113 sent to N access points (APs) 109. In one embodiment, the data streams 113 are I/Q samples of the N waveforms transmitted over the wireless link 110 from the APs 109. In this embodiment the AP consists of analog-to-digital/digital-to-analog (“ADC/DAC”), radio frequency (“RF”) chain and antenna. In a different embodiment, the data streams 113 are bits of information and MU-MAS precoding information that are combined at the APs to generate the N waveforms sent over the wireless link 110. In this embodiment every AP is equipped with a central processing unit (“CPU”), digital signal processor (“DSP”) and/or system-on-a-chip (“SoC”) to carry out additional baseband processing before the ADC/DAC units.

Typical downlink (DL) wireless links consist of broadcast physical channels carrying information for the entire cell and dedicated physical channels with information and data for given UE. For example, the LTE standard defines broadcast channels such as P-SS and S-SS (used for synchronization at the UE), MIB and PDCCH as well as channels for carrying data to given UE such as the PDSCH. In one embodiment of the present invention, all the LTE broadcast channels (e.g., P-SS, S-SS, MIC, PDCCH) are precoded such that every UE receives its own dedicated information. In a different embodiment, part of the broadcast channel is precoded and part is not. By way of example, but not limitation, the PDCCH contains broadcast information as well as information dedicated to one UE, such as the DCI 1A and DCI 0 used to point the UEs to the resource blocks (RBs) to be used over DL and uplink (UL) channels. In one embodiment, the broadcast part of the PDCCH is not precoded, whereas the portion containing the DCI 1A and 0 is precoded in such a way that every UE obtains its own dedicated information about the RBs that carry data.

In another embodiment of the invention, precoding is applied to all or only part of the data channels, such as the PDSCH in LTE systems. By applying precoding over the entire data channel, one embodiment of the MU-MAS disclosed in the present application allocates the entire bandwidth to every UE and the plurality of data streams of the plurality of UEs are separated via spatial processing. In typical scenarios, however, most, if not all, of the UEs do not need the entire bandwidth (e.g., ˜70 Mbps per UE, peak data rate for TDD configuration #2 in 20 MHz of spectrum). Then, one embodiment of the MU-MAS in the present application subdivides the DL RBs in multiple blocks as in OFDMA systems and assigns each block to a subset of UEs. All the UEs within the same block are separated through the MU-MAS precoding. In another embodiment, the MU-MAS allocates different DL subframes to different subsets of UEs, thereby dividing up the DL as in TDMA systems. In yet another embodiment, the MU-MAS both subdivides the DL RBs in multiple blocks as in OFDMA systems among subsets of UEs and also allocates different DL subframes to different subsets of UEs as in TDMA systems, thus utilizing both OFDMA and TDMA to divide up the throughput. For example, if there are 10 APs in a TDD configuration #2 in 20 MHz, then there is an aggregate DL capacity of 70 Mbps*10-700 Mbps. If there are 10 UEs, then each UE could receive 70 Mbps concurrently. If there are 200 UEs, and the aggregate throughput is to be divided up equally, then using OFDMA, TDMA or a combination thereof, the 200 UEs would be divided into 20 groups of 10 UEs, whereby each UE would receive 700 Mbps/200=3.5 Mbps. As another example, if 10 UEs required 20 Mbps, and the other UEs were to evenly share the remaining throughput, then 20 Mbps*10-200 Mbps of the 700 Mbps would be used for 10 UEs, leaving 700 Mbps-200 Mbps=500 Mbps to divide among the remaining 200−10=190 UEs. As such, each of the remaining 90 UEs would receive 500 Mbps/190=2.63 Mbps. Thus, far more UEs than APs can be supported in the MU-MAS system of the present invention, and the aggregate throughput of all the APs can be divided among the many UEs.

In the UL channel, the LTE standard defines conventional multiple access techniques such as TDMA or SC-FDMA. In one embodiment of the present invention, the MU-MAS precoding is enabled over the DL in a way to assign UL grants to different UEs to enable TDMA and SC-FDMA multiple access techniques. As such, the aggregate UL throughput can be divided among far more UEs than there are APs.

When there are more UEs than there are APs and the aggregate throughput is divided among the UEs, as described above, in one embodiment, the MU-MAS system supports a VRI for each UE, and the VRM controls the VRIs such that VRIs utilize RBs and resource grants in keeping with the chosen OFDMA, TDMA or SC-FDMA system(s) used to subdivide the aggregate throughput. In another embodiment, one or more individual VRIs may support multiple UEs and manage the scheduling of throughput among these UEs via OFDMA, TDMA or SC-FDMA techniques.

In another embodiment, the scheduling of throughput is based on load balancing of user demand, using any of many prior art techniques, depending upon the policies and performance goals of the system. In another embodiment, scheduling is based upon Quality of Service (QOS) requirements for particular UEs (e.g., that pay for a particular tier of service, guaranteeing certain throughput levels) or for particular types of data (e.g. video for a television service).

In a different embodiment, UL receive antenna selection is applied to improve link quality. In this method, the UL channel quality is estimated at the VRM based on signaling information sent by the UEs (e.g., SRS, DMRS) and the VRM decides the best receive antennas for different UEs over the UL. Then the VRM assigns one receive antenna to every UE to improve its link quality. In a different embodiment, receive antenna selection is employed to reduce cross-interference between frequency bands due to the SC-FDMA scheme. One significant advantage of this method is that the UE would transmit over the UL only to the AP closest to its location. In this scenario, the UE can significantly reduce its transmit power to reach the closest AP, thereby improving battery life. In the same embodiment, different power scaling factors are utilized for the UL data channel and for the UL signaling channel. In one exemplary embodiment, the power of the UL signaling channel (e.g., SRS) is increased compared to the data channel to allow UL CSI estimation and MU-MAS precoding (exploiting UL/DL channel reciprocity in TDD systems) from many APs, while still limiting the power required for UL data transmission. In the same embodiment, the power levels of the UL signaling and UL data channels are adjusted by the VRM through DL signaling based on transmit power control methods that equalize the relative power to/from different UEs.

In a different embodiment, maximum ratio combining (MRC) is applied at the UL receiver to improve signal quality from every UE to the plurality of APs. In a different embodiment zero-forcing (ZF) or minimum mean squared error (MMSE) or successive interference cancellation (SIC) or other non-linear techniques or the same precoding technique as for the DL precoding are applied to the UL to differentiate data streams being received from different UEs' areas of coherence. In the same embodiment, receive spatial processing is applied to the UL data channel (e.g., PUSCH) or UL control channel (e.g., PUCCH) or both.

### 1.2 Radios Daisy-Chained Over Coaxial Cable

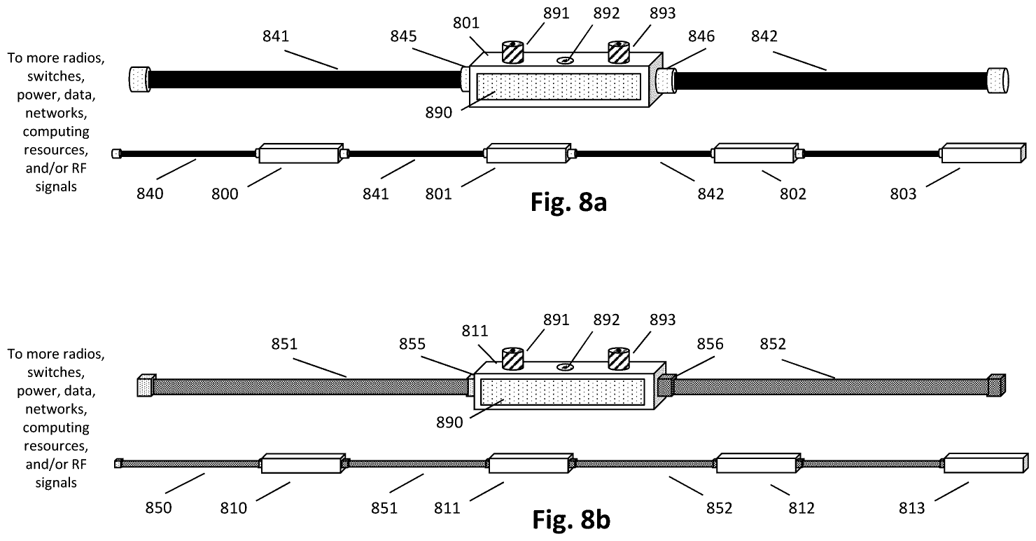

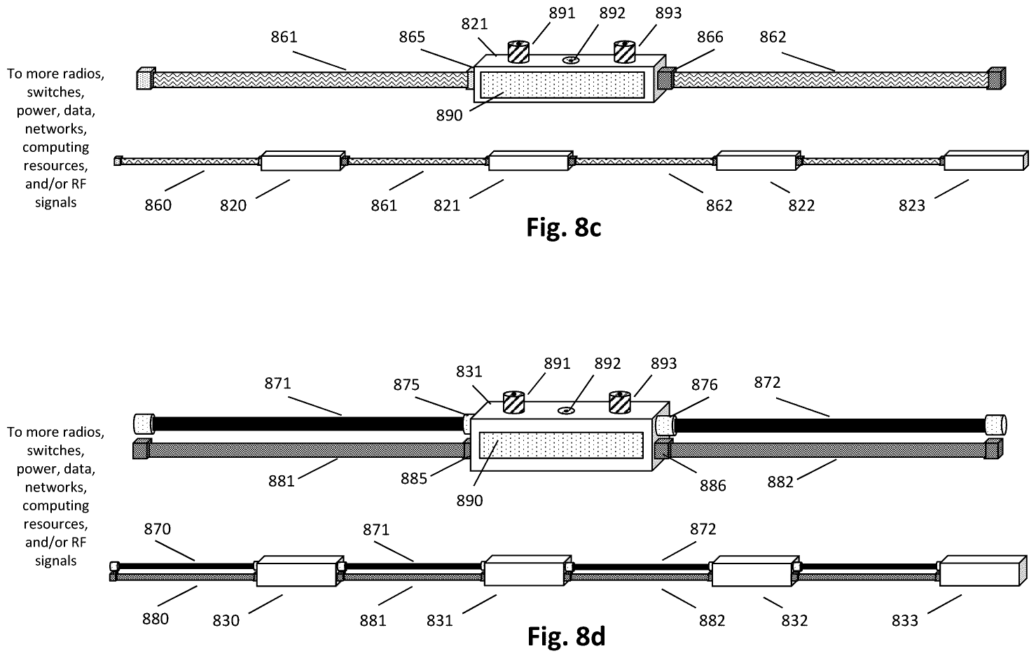

FIGS. 8a, 8b, 8c and 8d show several preferred embodiments of the present invention. FIG. 8a illustrates one embodiment in which radio 801 is a wireless transceiver. Each end of radio 801 has a connector (e.g. without limitation, F type, BNC, SMA, etc.) to which can be coupled to coaxial cable (e.g. without limitation, RG-6, RG-59, triaxial, twinaxial, semi-rigid, rigid, 50 ohm, 75 ohm, etc.) 841 through connector 845 on the left and can be coupled to coaxial cable 842 through connector 846 on the right. A smaller illustration of radio 801 is shown below the larger illustration. As can be seen in this smaller illustration (with most details removed), radio 801 can be daisy-chained through coaxial cable 841 with radio 800 on the left and daisy-chained through coaxial cable 842 on the right with radio 802. Radio 802 is, in turn, daisy-chained with radio 803 on the right. In this illustration, radio 803 is shown at the end of the daisy chain. Radio 800 is shown at the start of the daisy chain with coaxial cable 840 available for connections to, without limitation, more radios, power, data connections, networks, computing resources and/or RF signals, and/or other digital or analog signals. The radios 800, 801, 802, 803 and/or additional radios coupled to this daisy-chain may be radios of largely same or similar structure and/or configuration, or they may be quite different in structure and/or configuration.

The coaxial cable daisy chain can use any standard or proprietary network protocol including but not limited to, MoCA, Ethernet and/or DOCSIS, etc.

Turning again to the larger illustration (with details) of radio 801 above the daisy chain, in one embodiment radio 801 has one or more antennas 890 that may be internal to radio 801 enclosure or external to it. The antenna(s) can be any type of antenna, including without limitation patch antenna, dipole, monopole, printed circuit board (“PCB”) antenna, yagi, etc. In one embodiment there is a single antenna 890. In another embodiment there is more than one antenna 890, and another embodiment at least two antennas 890 are cross-polarized relative to each other. In another embodiment, antenna or antennas 890 are external to radio 801 and are coupled to one or more connectors 891, which may be a coaxial connector or other conductive connector, or may be through a non-conductive connector, including without limitation, an RF or inductive connection. An external antenna may also be coupled to radio 801 without coupling through a connector, including without limitation, via a fixed wired connection.

In one embodiment, radio 801 receives power from an external power source coupled through one or both coaxial cables 841 or 842, in either DC or AC power form. In another embodiment, radio 801 receives power from an external power source coupled to connector 892, which may be a connector of any type, including without limitation a DC or AC power connector (e.g. EIAJ-01, EIAJ-02, EIAJ-03, EIAJ-04, EIAJ-05, Molex connector, etc.). In another embodiment, radio 801 receives power conductively without a connector, including without limitation through a wired connection. In another embodiment, radio 801 receives power wirelessly, including without limitation receiving power wirelessly through a rectifying antenna, through an inductive coupling, through antenna 890, through an external antenna, through a photovoltaic cell, or through other wireless transmission means.

In one embodiment, radio 801 receives and/or transmits timing, calibration and/or analog or digital signals (collectively “Additional Signals” coupled through one or more connectors 893. The timing signals may include, without limitation, clock, pulse per second “PPS”, synchronization, and/or Global Positioning Satellite (“GPS”) signals. The calibration signals may include, without limitation, one or more of power level information, channel state information, power information, RF channel information, and/or pre-distortion information in analog and/or digital form. In one embodiment, these Additional Signals are received and/or transmitted wirelessly. In one embodiment, these Additional Signals are received and/or transmitted over coaxial cables 841 and/or 842. In one embodiment, these Additional Signals are transmitted and/or are received from radio 801. In one embodiment, the Addition Signals are transmitted and/or received from one or more external devices. In one embodiment, the one or more external devices are one or more additional radios in the MU-MAS. In one embodiment, the one or more external devices are one or more user devices in the MU-MAS. In one embodiment, the one or more external devices are one or more devices that are not are not radios in the MU-MAS.

### 1.3 Radios Daisy-Chained Over Twisted Pair Cable

FIG. 8b illustrates one embodiment in which radio 811 is a wireless transceiver similar to radio 801 disclosed above, except each end of radio 811 has network connectors 855 and 856 (e.g. without limitation, RJ-45, RJ-11 connectors) which can be coupled to twisted pair cables (e.g. without limitation, Category 3, Category 4, Category 5, Category 5e, Category 6, Category 6a, telephone wires, etc.) which would then connect to twisted pair cable 851 through connector 855 on the left and can be coupled to twisted pair cable 852 through connector 856 on the right.

The twisted pair cable daisy chain can use any standard or proprietary network protocol including but not limited to, Ethernet.

A smaller illustration of radio 811 is shown below the larger illustration. As can be seen in this smaller illustration (with most details removed), radio 811 can be daisy-chained through twisted pair cable 851 with radio 810 on the left and daisy-chained through twisted pair cable 852 on the right with radio 812. Radio 812 is, in turn, daisy-chained with radio 813 on the right. In this illustration, radio 813 is shown at the end of the daisy chain. Radio 810 is shown at the start of the daisy chain with twisted pair cable 850 available for connections to, without limitation, more radios, power, data connections, networks, computing resources and/or RF signals, and/or other digital or analog signals. The radios 810, 811, 812, 813 and/or additional radios coupled to this daisy-chain may be radios of largely same or similar structure and/or configuration, or they may be quite different in structure and/or configuration.

Turning again to the larger illustration (with details) of radio 811 above the daisy chain, it has connectors and features similar to those described for radio 801, above. In other embodiments radio 811 has one or more antennas 890 that may internal to the radio 811 enclosure or external to it, and one or more antenna connectors 891 as detailed relative to radio 801, above.

In one embodiment radio 811 receives power from an external power source coupled through one or both twisted pair cables 851 or 852, in ether DC or AC power form. In other embodiments radio 811 receives power from an external power source coupled to connector 892 and/or wirelessly as detailed relative to radio 801, above.

In one embodiment radio 811 receives and/or transmits Additional Signals coupled through one of more connectors 812. In one embodiment these Additional Signals are received and/or transmitted wirelessly. In one embodiment these Additional Signals are received and/or transmitted over twisted pair 851 and/or 852. In one embodiment these Additional Signals are transmitted and/or are received from radio 811. In other embodiments the Additional Signals are transmitted and/or received from one or more external devices as detailed relative to radio 801 above.

### 1.4 Radios Daisy-Chained Over Fiber Cable

FIG. 8c illustrates one embodiment in which radio 821 is a wireless transceiver similar to radios 801 and 811 disclosed above, except each end of radio 821 has network connectors 865 and 866 (e.g. without limitation, ST, DC, SC, LC, MU, MT-RJ, MPO connectors) which can be coupled to fiber cables (e.g. without limitation, multimode, single mode, etc.), which would then connect to either fiber cable 861 through connector 865 on the left and can be coupled to fiber cable 862 through connector 866 on the right.

The fiber cable daisy chain can use any standard or proprietary network protocol including but not limited to Ethernet and/or Common Public Radio Interface (“CPRI”), etc.

A smaller illustration of radio 821 is shown below the larger illustration. As can be seen in this smaller illustration (with most details removed), radio 821 can be daisy-chained through fiber cable 861 with radio 820 on the left and daisy-chained through fiber cable 863 on the right with radio 822. And, radio 822 is, in turn, daisy-chained with radio 823 on the right. In this illustration, radio 823 is shown at the end of the daisy chain. Radio 820 is shown at the start of the daisy chain with fiber cable 860 available for connections to, without limitation, more radios, power, data connections, networks, computing resources and/or RF signals, and/or other digital or analog signals. The radios 820, 821, 822, 823 and/or additional radios coupled to this daisy-chain may be radios of largely same or similar structure and/or configuration, or they may be quite different in structure and/or configuration.

Turning again to the larger illustration (with details) of radio 821 above the daisy chain, it has connectors and features similar to those described for radio 801 and 811, above. In other embodiments radio 811 has one or more antennas 890 that may be internal to the radio 811 enclosure or external to it, and one or more antenna connectors 891 as detailed relative to radio 801, above.

In one embodiment radio 821 receives power from an external power source coupled as transmitted light through one or both fiber cables 861 or 862 and converted to electric power (e.g. without limitation, via a photovoltaic cell or a rectifying antenna responsive to light wavelengths). In other embodiments radio 821 receives power from an external power source coupled to connector 892 and/or wirelessly as detailed relative to radio 801, above.

In one embodiment radio 821 receives and/or transmits Additional Signals coupled through one of more connectors 893. In one embodiment these Additional Signals are received and/or transmitted wirelessly. In one embodiment these Additional Signals are received and/or transmitted over fiber cable 861 and/or 862. In one embodiment these Additional Signals are transmitted and/or are received from radio 821. In other embodiments the Additional Signals are transmitted and/or received from one or more external devices as detailed relative to radio 801 above.

1.5 Radios Daisy-Chained Using More than One Type of Cable

In comparing radios 801, 811 and 821 we can see that they are structurally quite similar, with a distinction being that the daisy-chain cables are coaxial cables in the case of radio 801, twisted pair in case of radio 811 and fiber in the case of 821. Comparing coaxial cable and twisted pair cable, they have many similarities in terms of electrical characteristics including, without limitation, the ability to carry DC or AC power and the ability to carry RF signals. Depending on the particular type of coaxial or twisted pair cable, they can differ in terms of electrical or RF characteristics, without limitation, in their efficiency in carrying different DC or AC voltage or current, their efficiency in carrying different RF radiation wavelengths, their cable leakage in different RF radiation wavelengths, their impedance at different frequencies, their resistance to DC, the number of conductors in a cable, and the signal power they can carry.

In comparing fiber with twisted pair or coaxial cable, the primary difference is that fiber cable carries light radiation wavelengths and is not conductive for carrying electrical power or RF radiation wavelengths (e.g. at wavelengths below the light radiation wavelengths the fiber is designed to carry). Different types of fiber carry different light radiation wavelengths with different characteristics, but as a data transport medium, fiber cable typically suffers less loss in signal quality (e.g. without limitation, signal-to-noise ratio (“SNR”)) for a given distance than coaxial or twisted pair cable, making it feasible to maintain high signal quality for long distances that would be impractical for coaxial or twisted pair cable. Additionally, fiber generally can carry larger bandwidth and higher data rate signals in practice than coaxial or twisted paid cables. Fiber cables can be fabricated in the same cable sleeve with a conductive cable (e.g. without limitation, coaxial, twisted pair, or other conductive cable), so that conductively-coupled power and/or RF radiation wavelengths can be carried simultaneously with the light radiation on the fiber. Or, fiber cables can be tied or wrapped together with a conductive cable at the time of deployment to achieve a similar result.

Also, different specific cables have different physical characteristics that may be relevant in different deployment scenarios. They vary in thickness, weight, pliability, durability, ability to retard fire, cost, etc. The choice of which type of cabling (coaxial, twisted pair or fiber cable) used, and within each kind of cabling, the specific choice of each type of cabling (e.g. without limitation, RG-6, RG-89, Category 5e, Category 6, multimode single mode, etc.) and connector (without limitation, F-type, BNC, RJ-45, RJ-11, ST, DC) used to daisy-chain radios 801, 811 and/or 821 may be determined by a large number of factors including, without limitation, what cabling is already in place at the site of installation; the cost of cabling; the length of the cabling; the size, cost, power consumption, heat dissipation, performance characteristics of the radio 801, 811, 821 or 831; aesthetic considerations; environmental considerations; regulatory requirements; etc.

In some situations, characteristics of more than one type of cable for daisy-chaining may be desirable for a given radio. In one embodiment, illustrated in FIG. 8d, radio 831 uses two or more types of cables for daisy-chaining. Radio 831 has two different types of connectors on each side to accommodate two different types of cable, connectors 875 and 876 are coaxial cable connectors and connectors 885 and 886 are twisted pair connectors. Coaxial cable 871 and twisted pair cable 881 are connected to the left side and coaxial cable 872 and twisted pair cable 882 are connected to the right side. In another embodiment, one or the other connectors is a fiber connector to which a fiber cable is attached. In another embodiment, one, some or all of the daisy chain connectors on radios 801, 811, 821, or 831 are for different types of cable. In another embodiment one, some or all of the daisy chain connectors on radios 801, 811, 821, or 831 is a connector for a module with its own physical layer transceiver and connector, such as, without limitation, a small form-factor pluggable (“SFP”) module, to which can be connected a twisted pair, fiber, coaxial or some other form of cable.

A smaller illustration of radio 831 is shown below the larger illustration. As can be seen in this smaller illustration (with most details removed), radio 831 can be daisy-chained through cables 871 and 881 with radio 830 on the left and daisy-chained through cables 872 and 882 on the right with radio 832. And, radio 832 is, in turn, daisy-chained with radio 833 on the right. In this illustration, radio 833 is shown at the end of the daisy chain. Radio 830 is shown at the start of the daisy chain with cables 870 and 880 available for connections to, without limitation, more radios, power, data connections, networks, computing resources and/or RF signals, and/or other digital or analog signals. The radios 830, 831, 832, 833 and/or additional radios coupled to this daisy-chain may be radios of largely same or similar structure and/or configuration, or they may be quite different in structure and/or configuration. Similarly, radios 801, 811, 821 or 831 with daisy chain connector embodiments such as those described in the preceding paragraph can be daisy chained together. Antenna couplings (such as those described above with antenna 890, connector 891 or as described through other means), power couplings (such as those described above with connector 892 or as described through other means), and/or Additional Signal couplings (such as those described above with connector 893 or as described through other means) are applicable to radios 801, 811, 821 or 831 with daisy chain connector embodiments such as those described in the preceding paragraph.

### 2. Daisy-Chain Radio Architectural Embodiments

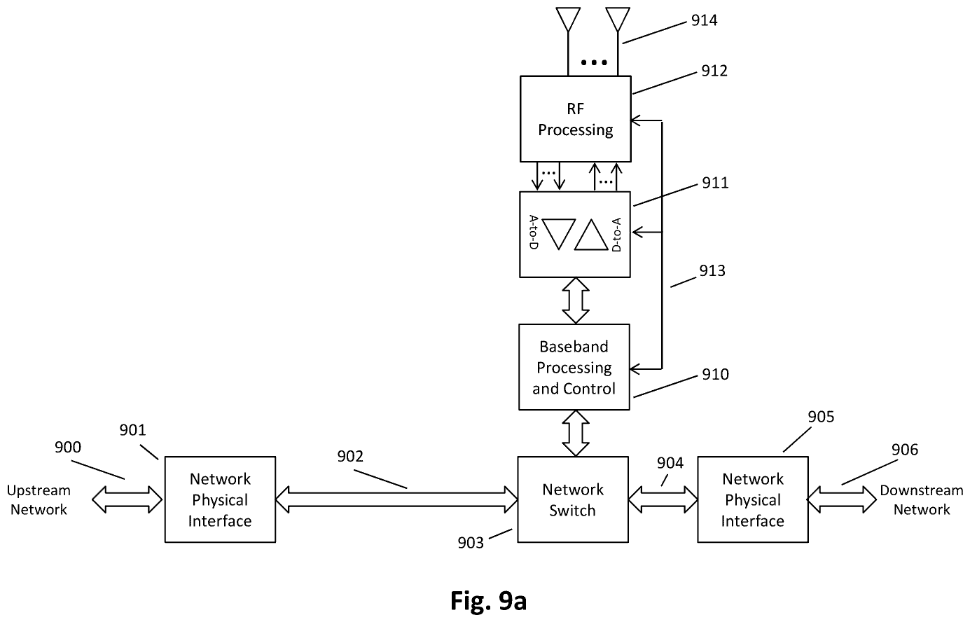

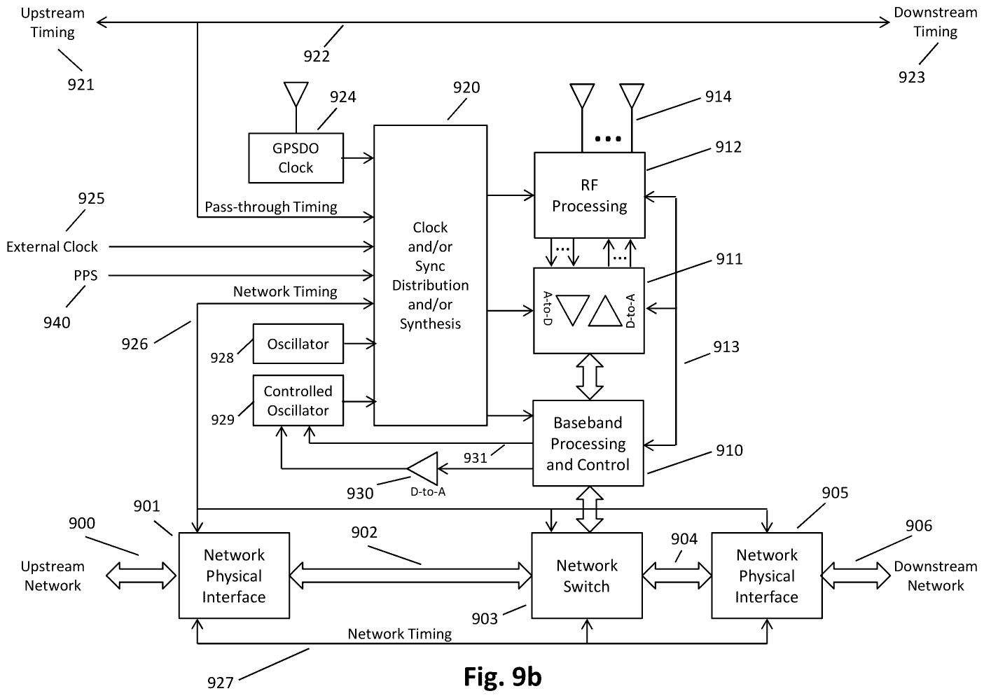

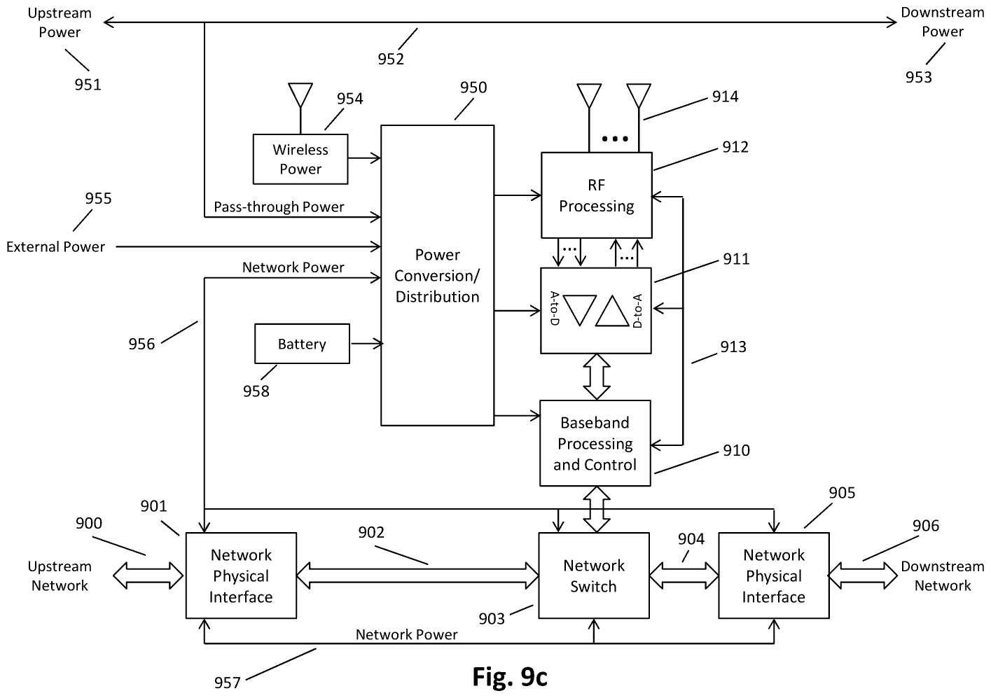

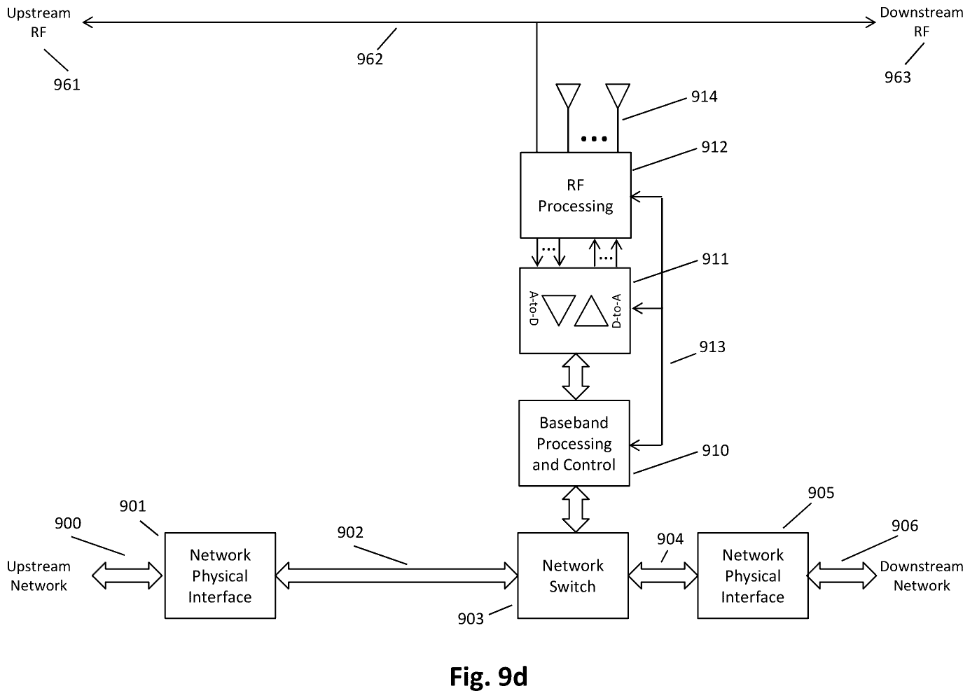

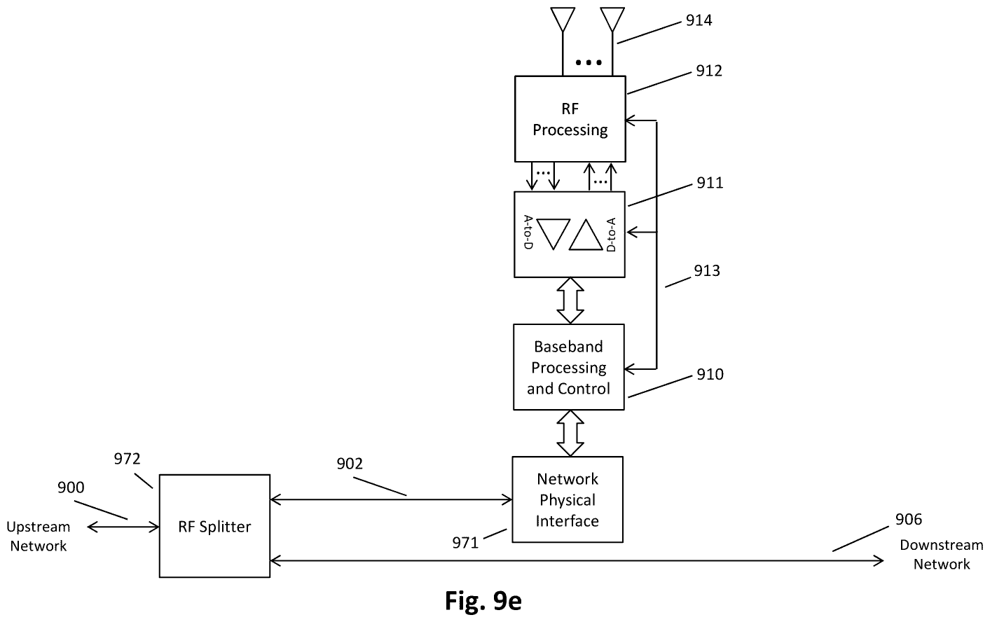

FIGS. 9a, 9b, 9c, 9d and 9e illustrate several embodiments of radios 801, 811, 821, and 831 of FIGS. 8a, 8b, 8c and 8d. Each of the embodiments illustrated in each of FIGS. 9a, 9b, 9c, 9d and 9e is applicable to any of the radios 801, 811, 821 and 831 that has the elements illustrated in a given figure.

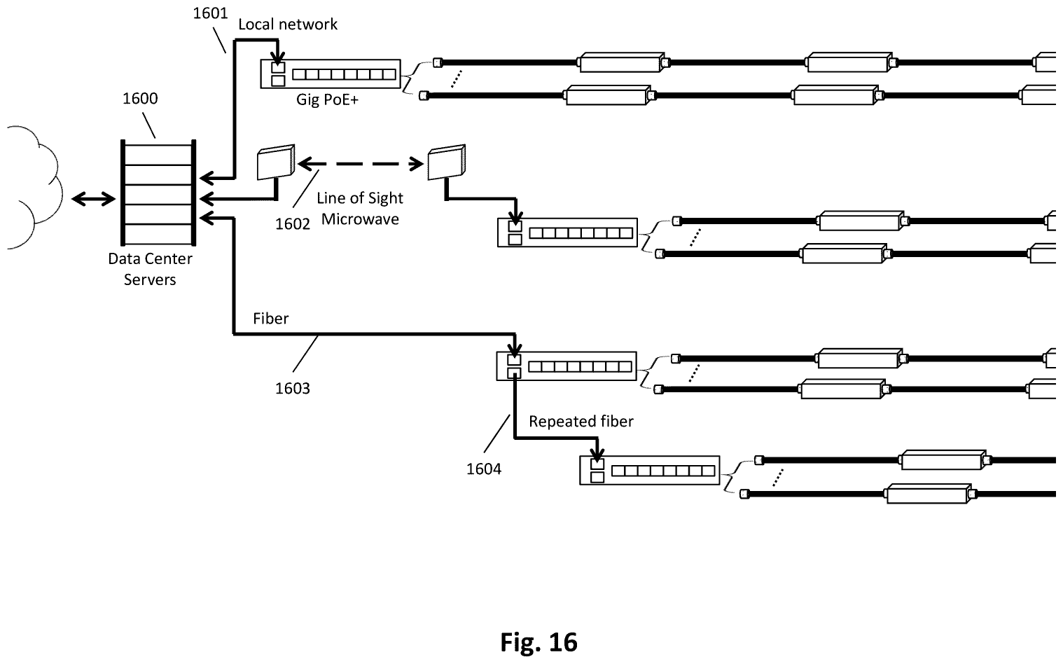

FIG. 9a illustrates a radio that can be inserted into a network daisy chain that is coupled through network links to a data center or other computing and/or data resource (detailed further below in connection with FIG. 16). Two network physical interfaces (PHYs) are illustrated in FIG. 9a, with PHY 901 coupled to upstream network 900 (by “upstream” meaning closer in the daisy chain to the data center) and PHY 901 connected to downstream network 906 (by “downstream” meaning further in the daisy chain to the data center). PHY 901 is coupled to network switch 903 though physical interconnect 902 (e.g. without limitation, bus, serial interconnect, etc.) and PHY 906 is coupled to network switch 903 through physical interconnect 904. Network switch 903 can be configured to either route data upstream or downstream between the PHYs 905 and 901 (thus enabling a network “pass through”) and/or can be configured to route some or all data through physical interconnect to baseband processing and control unit 910. In one embodiment the switch is configured for a particular routing of some or all data. In another embodiment the switch is configured to route data based on source or destination address associated with the data (e.g. without limitation, IP address) of the data.

Network switch 903 is coupled to baseband processing and control unit 910, which processes data packets to/from network switch 903 either as data (e.g. without limitation, 8-bit, 16-bit, 24-bit, 32-bit or any length data samples; fixed-length numeric values, floating-point numeric values, compressed numeric values, bit-coded numeric values) to be streamed (e.g. without limitation, transferred as successive samples) to/from the A-to-D/D-to-A unit 911, or uses them as control data.

Data to be streamed to/from unit 910 are either streamed directly without further processing to/from unit 910 or additional processing is applied to the data stream. Additional processing may include, without limitation, buffering the data; holding the data to be released with a specific trigger or timing event; compressing and/or decompressing the data; filtering the data through, without limitation, finite impulse response (FIR) or other filters; resampling the data to a different clock rate either higher or lower than the received clock rate, or with a different time reference; scaling the amplitude of the data; limiting that data to maximum values; deleting data samples from the stream; inserting data sample sequences in the stream; scrambling or descrambling the data; or encrypting or decrypting the data; etc. Unit 910 may also include either dedicated hardware or a computing means to implement, without limitation, part or all of the operations referenced in this paragraph and/or part or all of the function of a wireless protocol, which it may implement while awaiting, sending or receiving data (either to/from network switch 903 or to/from unit 912 and after A-to-D/D-to-A conversion in unit 911).

Data to/from unit 903 may be used as control data, without limitation, to send and receive messages to/from any subsystem in the radio, both within unit 910 and also to/from other units, for example, without limitation, as shown with interconnect 913 connecting to/from unit 910 and RF processing unit 912. The messages may be used for any purpose whatsoever including, without limitation, configuring any of the subsystems in the radio; reading the status of any subsystems in the radio; sending or receiving timing information; rerouting data streams; controlling power levels; changing sample rates; changing transmit/receive frequencies; changing bandwidth; changing duplexing; switching between transmit and receive mode; controlling filtering; configuring the network mode; loading an image to or reading an image from a memory subsystem; or loading an image to or reading an image from a field-programmable gate array (FPGA), etc.

The A-to-D/D-to-A unit 911 converts digital data samples received from unit 910 to one or more analog voltages and/or currents coupled to RF processing unit 912 and converts one or more analog voltages and/or currents from unit 912 to digital data samples send to unit 910. Unit 911 can be implemented as receiving data in parallel or serial form, with any data sample size and any data rate, either fixed or configurable.

In the transmit path, the one or more analog voltages and/or currents received by the RF processing unit 912 may be coupled as RF signals directly to the one or more antenna outputs 914, or the signals may be used as one or more baseband signals that are modulated onto one or more carrier frequencies that are synthesized by the RF processing unit into an RF waveform, and then the modulated signals on the carrier frequencies are coupled to one or more antennas 914. The signals from unit 910 may be in the form of, without limitation, baseband waveforms or baseband I/Q waveforms.

In the receive path, received RF signals from the one or more antennas 914 are either directly coupled as voltages and/or currents to unit 911, or the signals are demodulated from one or more carrier frequencies to either baseband waveforms or baseband I/Q waveforms that are coupled as voltages and/or currents to unit 911 to be converted to a data stream.

RF unit 912 may include, without limitation, other RF processing functions including power amplifiers, low noise amplifiers, filters, attenuators, circulators, switches, and baluns, etc.

Antennas 914 may be any type of antenna including, without limitation, patch antennas, dipoles, monopoles, or a PCB antenna, yagis, etc. In one embodiment there is a single antenna 890. In another embodiment there is more than one antenna 890, and another embodiment at least two antennas 890 are cross-polarized relative to each other.

FIG. 9b illustrates additional embodiments of the radios illustrated in FIG. 9a showing different embodiments of clocking subsystems. Unit 920 is a clock and/or sync distribution and synthesis unit, which may be implemented, without limitation, in a single device or in a plurality of devices. It distributes timing signals, including, without limitation, clock and sync signals to other subsystems within the radio. As illustrated in FIG. 9b these subsystems may include, without limitation, baseband and control unit 910, A-to-D/D-to-A unit 911, RF processing unit 912, network PHY 901, network switch 903 and/or network PHY 902. The timing signals distributed to different subsystems may be, without limitation, the same timing signals, different timing signals that are synchronous to each other, different timing signals that are asynchronous to each other, timing signals that are synchronous to external reference and/or timing signals that have synchronous or non-synchronous changes based on, without limitation, configuration or other factors.

The timing signals may be at any frequency, including without limitation, 10 MHz, and the timing signals may be, without limitation, the same frequency, different frequencies, varying frequencies and/or variable frequencies. The timing signals may use any timing reference, including without limitation, external references, internal references, or a combination of external and internal references.

External timing references include, without limitation, timing references 922 derived from timing references carried through the daisy chain, whether upstream 921 to downstream 923 or downstream 923 to upstream 921; a Global Positioning Satellite Disciplined Oscillator (“GPSDO”) 924, which derives timing references (e.g. 10 MHz clock and PPS) from radio signals received from Global Positioning Satellites; an external clock reference; an external PPS 940; and/or network timing signals derived from either the upstream network 900 or downstream network 906 by network PHY 901, network switch 903, and/or network PHY 905. Network timing references include, without limitation, timing references derived from Ethernet SyncE (e.g. ITU G.8261, ITU G.8262, ITU G.8264, etc.); IEEE 1588 Precision Time Protocol; and/or clocks and sync signals derived from the network signals, protocols or traffic.

Internal timing references include, without limitation, oscillator 928 and/or controlled oscillator 929. Oscillators 928 and 929 can be of any type of oscillator, without limitation, quartz crystal oscillator, rubidium clock, cesium clock, and/or resistor-capacitor network oscillator, inductor-capacitor resonant circuit. Oscillators 928 and 929 may be of any level of stabilization including, without limitation, non-stabilized; temperature-compensated oscillators, and/or oven-controlled oscillators. Oscillators 928 and 929 may be of any level of precision including, without limitation, low-precision, 1 part per million (“ppm”); 1 part per billion (“ppb”); have any precision in each frequency ranges, have any Allan Deviation, have any short-term or long-term stability. Oscillator 929 may have an external input that controls its frequency by controlling with, without limitation, an analog value of voltage, current, resistance, etc.; a digital value, coupled serially, in parallel, etc.; and/or a frequency, etc. If oscillator 929 is controlled by an analog value, it can be controlled by, without limitation, a potentiometer in a voltage divider network, a digital-to-analog converter 930, which receives a digital value 931 from unit 910 or another source, etc. If oscillator 929 is controlled by a digital value, it can be controlled by, without limitation, a digital value 931 from unit 910 or another source, etc. Controlled oscillator 929's frequency can be free-running, or synchronized to any type of internal or external timing source including, without limitation, timing from the network, timing from the daisy chain separate from the network, timing from the data center, timing from a wireless protocol, etc.

The timing on the daisy chain network can be free-running or it can be synchronous, using any number of network synchronization methods, including without limitation, SyncE and/or IEEE 1588, etc. A synchronous protocol may have its own self-synchronization mechanisms, or timing signals 927 can be passed from one network PHY 901 or 905 to the other and/or to/from network switch 903.

FIG. 9c illustrates additional embodiments of the radios illustrated in FIG. 9a and FIG. 9b showing power conversion and distribution systems. Unit 950 Power conversion/distribution unit and it may be implemented, without limitation, in a single device or a plurality of devices to implement conversion and distribution of power through couplings, (e.g. without limitation, wires, printed circuit board traces, and/or through components, wireless transmission, etc.) to the various subsystems. Until 950 distributes power, including, without limitation, different voltages; different independent power buses (whether the same or different voltage); different current levels; AC or DC power; wireless power; etc. within the radio. As illustrated in FIG. 9c subsystems receiving power from unit 950 may include, without limitation, baseband and control unit 910, A-to-D/D-to-A unit 911, RF processing unit 912, network PHY 901, network switch 903 and/or network PHY 902. The power couplings distributed to different subsystems may be, without limitation, the same power couplings; different power couplings that are the same or different voltages and/or currents; and/or variable voltages, etc.

The power may be at any voltage or current, including without limitation, AC, DC, 1 Volt (“V”), 2.2V, 3.3V, 5V, −5V, 6V, 12V, variable voltages. The power may be from any source, including without limitation, external sources, internal sources, or a combination of external and internal sources.

External power sources include, without limitation, pass-through power source 952 derived from a power source carried through the daisy chain, whether upstream power coupling 951 to downstream power coupling 953 or downstream power coupling 953 to upstream power coupling 951; wireless power 954, which can come from, without limitation, radio wave transmissions (e.g., without limitation received by a rectifying antenna), inductive power (e.g., without limitation coupled through a transformer), light energy (e.g. without limitation coupled through a photovoltaic cell, a rectifying antenna, etc.); network power carried through the daisy chain network, either through a direct coupling 957 from upstream network 900 to the downstream network 906, or through a switching and/or power insertion in one or both network PHYs 900 or 905 or network switch 903; through network power coupling 956 from network PHY 901, 903 or 905; and/or an external power connection 955, via, without limitation, a cable, a jack, conductive contacts; etc.

Power transmission through the daisy chain via upstream power coupling 951 to/from downstream power coupling 953, or via upstream network 900 to/from downstream network 906 may be either always passed through, or it may be only be allowed to pass through if the radio is configured to do so or external conditions (e.g. detection of a suitable device connected to either end of the daisy chain) trigger power being allowed to pass through. Any type of device can be used to control whether power passes through including, without limitation, a mechanical relay and/or a transistor, including, but not limited to, a metal-oxide semiconductor field-effect transistor (MOSFET), etc.

Internal power sources include any type of battery 958, including without limitation lithium ion, lithium polymer, fuel cells and electrical generators.

FIG. 9d illustrates additional embodiments of the radios illustrated in FIG. 9a, FIG. 9b and FIG. 9c showing upstream 961 and downstream 963 RF links coupled to RF processing unit 912. RF links 961 and 963 may be coupled in the daisy chain over a conductive coupling, for example without limitation, coaxial cable, twisted pair cable, etc., or through fiber if the RF frequencies modulate carrier wavelengths that propagate through fiber (e.g. without limitation, infrared radiation, visible light radiation, and/or ultraviolet radiation, etc.), or over a wireless coupling including, without limitation, over any kind of antenna, and/or through an inductive coupling.

RF links 961 and 963 may be coupled together over RF link 962 and then coupled to unit 912 as illustrated in FIG. 9d or they each may be coupled individually to unit 912, or they be coupled to each other, but not to unit 912. Each of these couplings, whether between each other or to unit 912 may be through any of the RF (including light wavelength) couplings as detailed in the preceding paragraph. The couplings may be via, without limitation, one or more (or any type): direct connections; RF splitters; RF attenuators; RF baluns; RF filters; power amplifiers; and/or low noise amplifiers, etc. The RF couplings may not be connected to anything, or connected to one or more of the antennas 914. The RF couplings may carry signals at one or more RF center frequencies and of one or more bandwidths. The RF signals may be transmitted, received, or both at once to/from any of unit 912, link 961 and/or link 963. The RF signals may carry any kind of information and/or signal reference information including without limitation, data, control signals, RF protocols, beacons, RF timing signals, RF channels, RF power references, RF pre-distortion information, RF interference information, RF calibration information, clocks, and/or PPS.

FIG. 9e illustrates additional embodiments of the radios illustrated in FIG. 9a, FIG. 9b, FIG. 9c and FIG. 9d showing upstream 900 and downstream 906 networks links where the network is a common RF channel, rather than switched links. For example, this is a common configuration used with coaxial networks using network protocols such as, without limitation, MoCA and DOCSIS. Upstream 900 and downstream 906 network links are coupled to RF splitter 972, which is coupled to network PHY 971, which is coupled to baseband processing and control 910. RF splitter 972 may include more than 3 branches, and further, it may include a power amplifier to amplify some or all of the RF signals in one or more directions. It may also include attenuators and/or filters to limit which RF bands pass through it in different paths. RF splitter 972 may also pass through power onto one or more or a plurality of branches, and it may also insert power onto one or more of its branches.

Embodiments of the radios 801, 811, 821 and 831 illustrated in FIGS. 8a, 8b, 8c and 8d may have internal elements that correspond to one or more of the embodiments described in FIGS. 9a, 9b, 9c, 9d and 9e above, sometimes as independent elements, and sometimes as combined elements. For example, without limitation, each of radios 801, 811, 821 and 831 has an upstream and downstream daisy chain cable connection, that is either coaxial (e.g. 841/842 and 871/872), twisted pair (e.g. 851/852 and 881/882) or fiber (e.g. 861/862). These daisy chain connections can correspond to embodiments in FIGS. 9a, 9b, 9c, 9d and 9e that are upstream and downstream daisy chain connections, such as 900/906, 911/923, 951/953 and 961/963. If the daisy chain cable in radio 801, 811, 821 or 831 is physically capable of an embodiment described connection with FIGS. 9a, 9b, 9c, 9d and 9e, then that daisy chain cable can be used for that embodiment. For example, coaxial and twisted pair cable daisy chains can be used to carry upstream 951 and downstream 953 power conductively (e.g. without limitation using any of many well-known power over coax or power over Ethernet technologies), but fiber cable cannot, however, fiber cable can carry power transmitted in the form of light and converted to electricity, e.g. without limitation, using a photovoltaic cell. Each of the daisy chain cables can also carry upstream 900 and downstream 906 standard and proprietary network protocols, including without limitation, Ethernet, as noted above. All of the daisy chain cables can also carry timing information 921 and 923 and with network protocols and signals carrying timing information, they can provide network timing 926. The daisy chain cables can carry upstream 961 and downstream 963 RF at certain frequencies/wavelengths (e.g. without limitation, many coaxial cables can propagate 1 GHz frequencies efficiently, many twisted pair cables propagate 100 MHz frequencies efficiently and many fiber cables propagate 1300 nm wavelengths efficiently).

In the case of radio 831, the multiple daisy chain cable pairs can each correspond to one of the daisy chain connections illustrated FIGS. 9a, 9b, 9c, 9d and 9e, or each to multiple daisy chain connections.

Antennas 890 and/or antenna connectors 891 of radios 801, 811, 821 or 831 can correspond to antennas 914 and/or antennas on units 924 and/or 954 of FIGS. 9a, 9b, 9c, 9d and 9e.

Power connector 892 of radios 801, 811, 821 or 831 can correspond to external power 955 of FIGS. 9a, 9b, 9c, 9d and 9e. Antennas 890 and/or antenna connectors 891 of radios 801, 811, 821 or 831 can also correspond to the antennas of wireless power receiver 954.

Connector 893 of radios 801, 811, 821 or 831 can carry Additional Signals that correspond to External Clock 925, PPS 940, or RF link 962 coupled to unit 912.

3. Radio Daisy Chains within Sleeves or Ducts

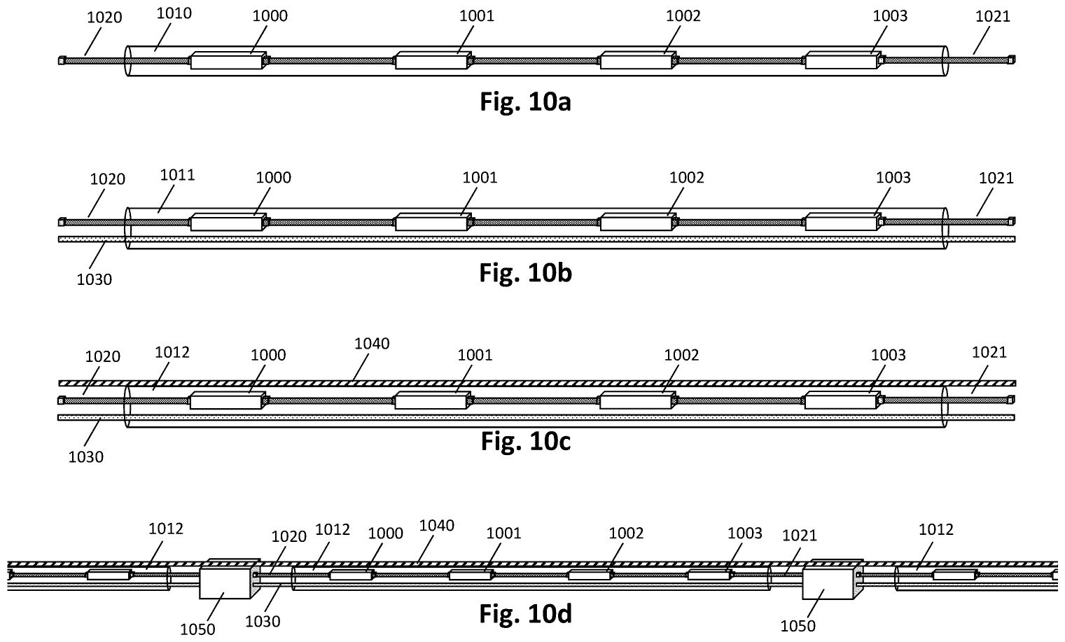

FIGS. 10a, 10b, 10c and 10d illustrate several embodiments in which the radio daisy chain radio embodiments illustrated in FIGS. 8a, 8b, 8c and 8d and described above with daisy chain radio architecture embodiments illustrated in FIGS. 9a, 9b, 9c, 9d and 9e and described above are housed within sleeves or ducts. For the sake of illustration the daisy chain radios shown in FIGS. 10a, 10b, 10c and 10d lack many of the details of daisy chain radios described above, but any of the above daisy chain embodiments that is applicable to a sleeve or duct embodiment illustrated in any of FIGS. 10a, 10b, 10c and 10d can be used in that embodiment. Note that sleeves or ducts can come in many forms, including without limitation, flexible plastic tubes that entirely envelope radio daisy chains, or rigid plastic ducts that partially envelope the radio chains.

FIG. 10a illustrates a sleeve or duct 1010 encapsulating a daisy chain of radios 1000, 1001, 1002, 1003. The daisy chain shows the network cables 1020 and 1021 extending from both sides and they can be connected to, without limitation, additional daisy chains or radios, upstream or downstream network connections, to power sources, to RF sources to timing sources, etc. Indeed, the daisy chain connection can be connected as described in any of the large number of embodiments described above.

FIG. 10b illustrates a sleeve or duct encapsulating a daisy chain of radios. The daisy chain shows the radio daisy chain described in the preceding paragraph, but in this embodiment sleeve or duct 1011 also encapsulates pass-through cable 1030. Pass-through cable 1030 could be a cable used for any purpose, including without limitation, coaxial, twisted pair or coaxial cable carrying high data rate data and/or a power cable. There may be one or multiple pass-through cables 1030.

FIG. 10c illustrates a sleeve or duct 1012 encapsulating a daisy chain of radios and a pass-through cable as described in the preceding paragraph, but in this embodiment the sleeve or duct is physically strengthened by a support strand 1040 and may be made of any of wide range of materials, including galvanized steel. An example of such a sleeve or duct 1012 with galvanized steel support strand is “FIG. 8”-branded duct from dura-line, with a specification currently available at http://www.duraline.com/conduit/figure-8. The support strand 1040 can help support the duct in an aerial deployment of the duct, e.g., between utility poles.

FIG. 10d illustrates the sleeve or duct 1012 (in a reduced-size illustration) encapsulating a daisy chain of radios and a pass-through cable with a support strand 1040 as described in the preceding paragraph, but in this embodiment the sleeve or duct daisy chain 1012 is connected in a continuing daisy chain with other sleeves or ducts. In this embodiment, between each sleeve or duct daisy chain 1012, there is a data and/or power coupler 1050 that may be used, without limitation, to couple power into the daisy chain end 1020 or 1021 and/or may be used to couple data to/from the daisy chain end 1020. Data and/or power coupler 1050 can be suspended from support strand 1040 or physically supported through another means. The power may come from any power source, including without limitation, a pass-through power cable 1030 and/or photovoltaic cell, etc. The data connection may come from any source including a pass-through high-bandwidth fiber twisted pair or coaxial cable 1030. Data and/or power coupler 1050 can be useful because the daisy chain cabling will typically be limited in power and/or data throughput, and each radio 1000, 1001, 1002 and 1003 on the daisy chain will draw a certain amount of power and consume a certain amount of data throughput. Once the power and/or data capacity of the daisy chain cable is exhausted, then there can be no more radios attached to the daisy chain. The pass-through cable 1030 can be specified to carry enough power for several daisy chains and the pass-through cable 1030 can be specified to support high enough data throughput to support several daisy chains. For example, without limitation, if the daisy chain cable supports 1 gigabit Ethernet with Power over Ethernet+ (“PoE+”) power limitations (limited to roughly 25 watts (“W”)), and each radio consumes 225 Mbps in data rate and 6 W in power, then if there are 4 radios in a daisy chain there will be 900 Mbps of data rate and 24 W in power and there will not be enough data rate or power for another radio. If there are one or more pass-through cables 1030 that can (a) carry 250 W of power and (b) 10 Gbps of data rate, then that will be enough to support 10 daisy chains of 4 radios (24 W*10=240 W, 900 Mbps*10=9 Gbps). The data and/or power coupler 1050 can couple power to the daisy chain cable in any of many ways, including using a commercially-available PoE+ switch with a 10 Gbps fiber port and one or more 1 Gbps PoE+ ports. Note that while the PoE+ standard (e.g. IEEE 802.3at-2009) may not support daisy chaining of power, PoE+ can still be used to bring power to the first daisy chain radio attached to the PoE+ switch, and proprietary power insertion onto the daisy chain can be used thereafter. Proprietary power insertion techniques include, without limitation, coupling the power to network signal wires in the daisy chain network cable.

### 3. Practical Deployments of Radio Daisy Chains

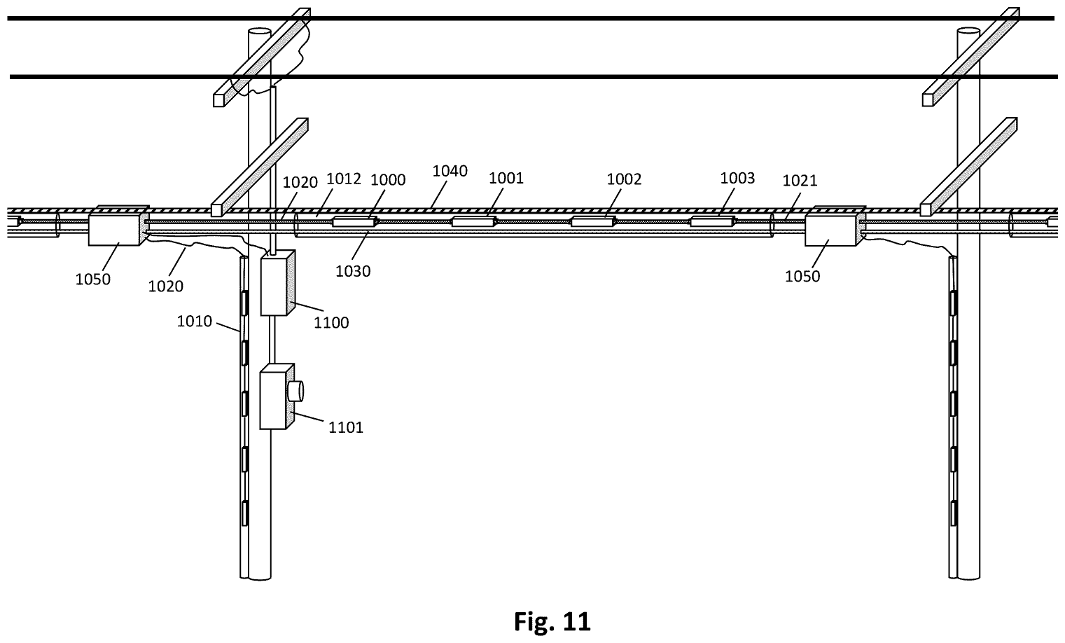

FIG. 11 illustrates utility poles with daisy chained radios in sleeves and ducts, such as those described in FIGS. 10a and 10d. The sleeve or duct 1012 suspended between the two utility poles is the same as illustrated in FIG. 10d with 4 daisy chained radios 1000, 1001, 1002, and 1003, with a daisy chain end coupled to data and/or power coupler 1050, which couples to high-speed data from pass-through cable 1030, and receives power from power converter 1100, that is coupled to the high power electrical lines in the supply zone of the utility pole and reduces the voltage for unit 1050. Power meter 1101 monitors power use for billing or other purposes. Because it can be expensive to connect to the high voltage electrical lines, power converter 1100 may be used to provide enough power to many unit 1050s, with power carried between unit 1050s in a pass-through strand 1030.

Also illustrated in FIG. 11 is an embodiment of a vertical deployment of daisy chained radios in a sleeve or duct 1010 attached to the side of the utility pole. This corresponds to sleeve or duct 1010 illustrated in FIG. 10a. On one end, the daisy chain network connection 1020 attaches to unit 1050 for data and power. Since this daisy chain ends when it reaches the ground, there is no need for a continuing daisy chain network connection at the bottom end, nor is there a need for a pass-through cable. Also, because the utility pole provides structural stability, there is no need for a support strand. Note also that the unit 1050 is coupled to 3 daisy chains, the two largely horizontal aerial daisy chains between utility poles and the one vertical daisy chain on the side of the pole. There is no restriction that all daisy chains must be sequential line network topology; they can be in any of many topologies. For example, without limitation, this unit 1050 could support 3 daisy chains by using a PoE+ network switch with 3 ports for the 3 daisy chains and 1 port for the high bandwidth pass-through cable. (e.g. 3 1 Gbps PoE+ connections to the 3 daisy chains and 1 10 Gbps fiber connection for the pass-through cable).

The embodiments of daisy chain cables shown in FIG. 11 are just exemplary. Depending on, without limitation, the deployment requirements, municipal regulations, cost constraints, distance of spans, etc., any number of daisy chain radio configurations in any topology may be used. Significantly, the radio daisy chains look no different than cabling. In many municipalities, cabling does not require permits, or the permits are easier to obtain than antenna permits. Also, from an aesthetic standpoint, cables are less visible than large antennas.

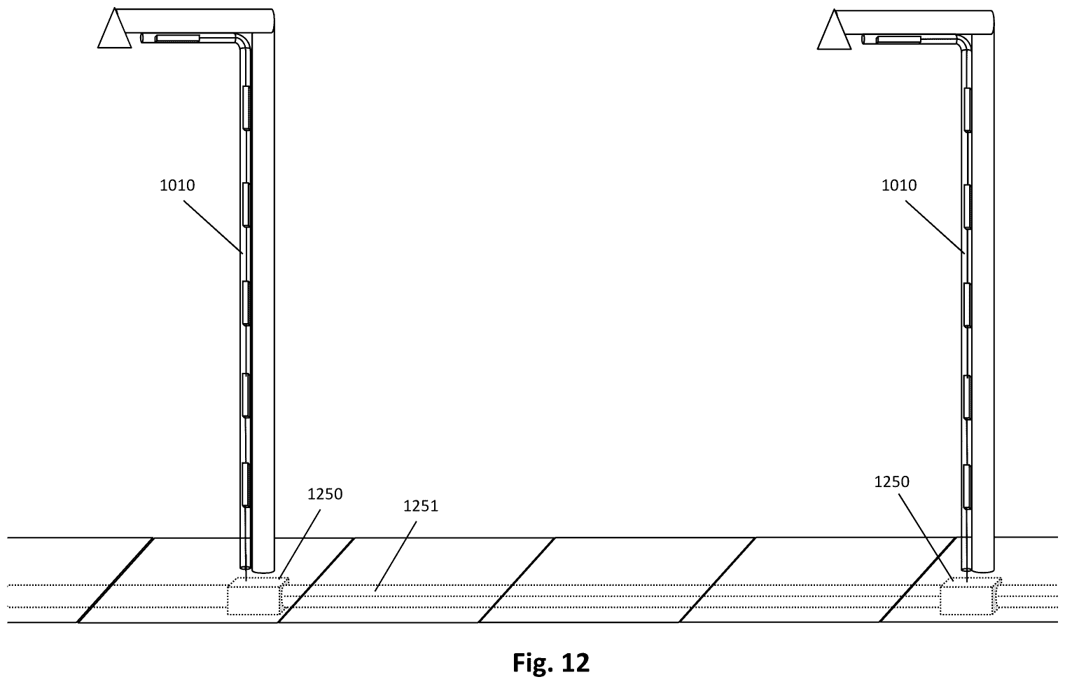

FIG. 12 illustrates two lamp posts with radio daisy chains 1010 attached to them. The embodiment illustrated conforms to the radios daisy chains 1010 from FIG. 10a. In this embodiment data and power connections are coupled through underground conduit 1251, with a data and/or power coupler 1250 underneath the pole, operating in the same manner as data and power coupler 1050 illustrated in FIG. 10d and FIG. 11. As in FIG. 11, significantly, the radio daisy chains look no different than cabling. In many municipalities, cabling does not require permits, or the permits are easier to obtain than antenna permits. Also, from an aesthetic standpoint, cables are less visible than large antennas.

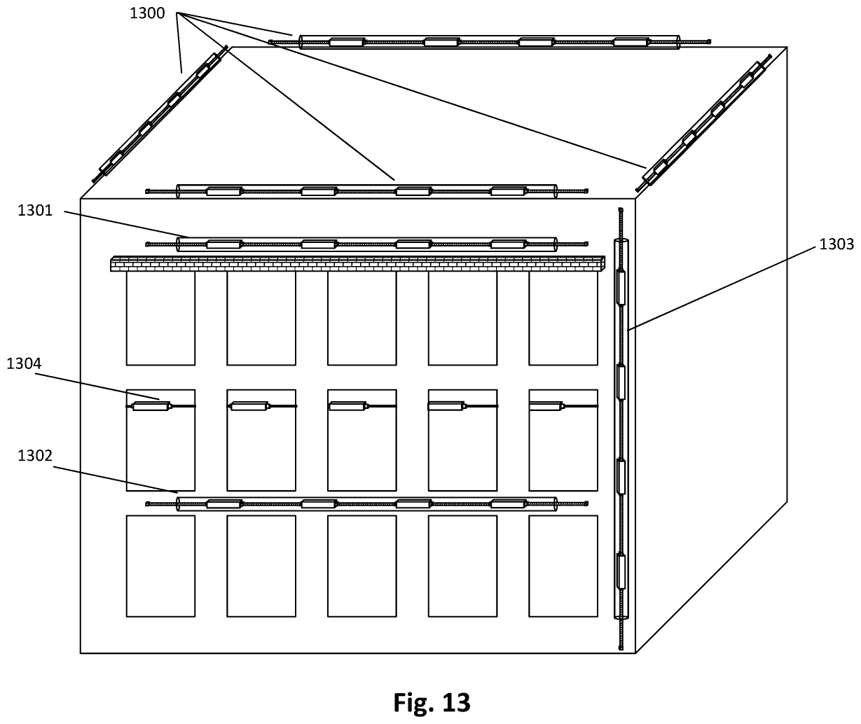

FIG. 13 illustrates a building with many radio daisy chains attached to both the outside and inside of the building. All of these radio data chains would connect to data and power connections, but they have been omitted for the sake of illustration. Radio daisy chains 1300 are on the edge of the rooftop. A rooftop edge is a highly advantageous location for antennas because there is high angle visibility to the street without obstruction. Typically, a large number of antennas on the edge of a rooftop would be unsightly aesthetically, but a sleeve or duct can be made to be hardly visible, because, without limitation, its small size, its ability to be painted in a color matching the background, the fact it can be placed in a niche on the building, the fact it is flexible and can conform to the shape of the architecture features (e.g. without limitation, a cornice) on the building, and because there are already cables on many buildings and it will look no different.

FIG. 13 shows other placements of radio daisy chains, including radio daisy chain 1301 above an architectural feature over windows to make it less visible, and radio daisy chain 1302, that is placed along the wall near street level (perhaps pressed into a niche on the wall to be more hidden) and radio daisy chain 1303 vertically along the corner of a wall, perhaps placed along a downspout to be less visible. Also radio daisy chain 1304 is shown indoors, perhaps above ceiling tiles or in walls. Note that in this embodiment, the radio daisy chain is not in a sleeve or duct because there will be situations where none is needed and the daisy chain can be placed with the radios and cables exposed. Clearly radio daisy chains can be placed in a wide range of locations, indoors and outdoors. In all of these embodiments, the radio daisy chains are deployed where it is convenient to deploy them and where they are aesthetically acceptable.

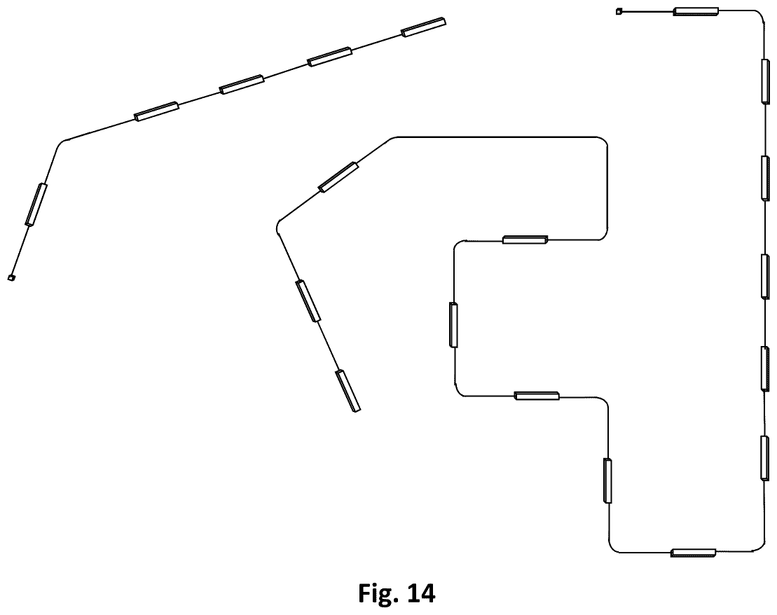

FIG. 14 illustrates how the radio daisy chains do not need to be deployed in a straight line, but can be deployed in whatever shape conforms to the physical and/or aesthetical requirements of the location. Note they need not be deployed in only 2 dimensions; radio daisy chains can be deployed in x, y and z dimensions. In fact, the more angular diversity is used, generally the better the performance in the presently preferred MU-MAS embodiment.

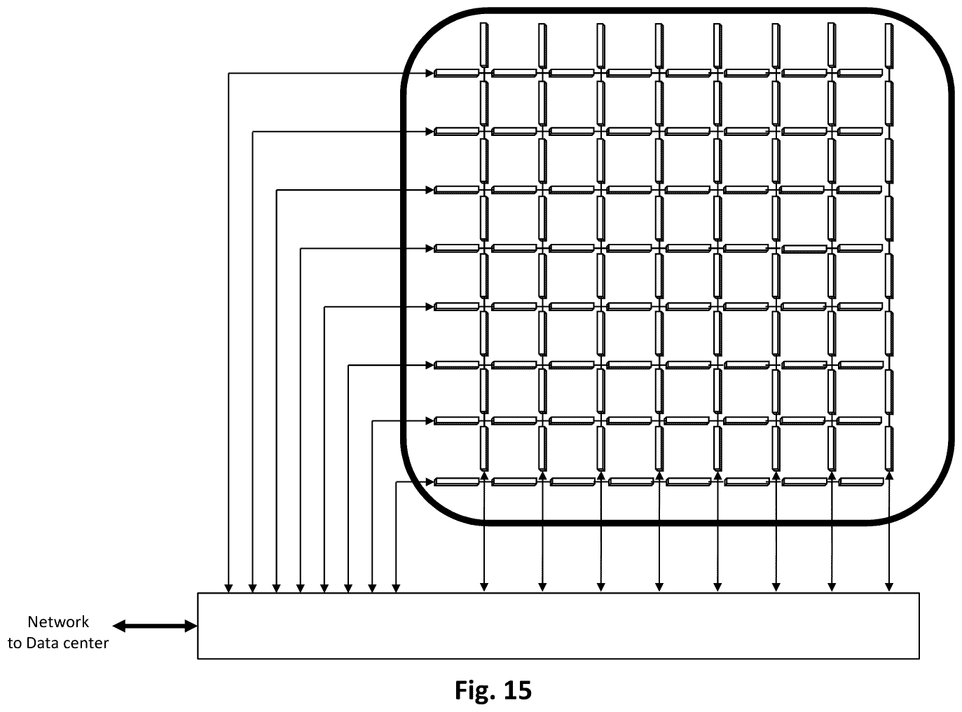

FIG. 15 illustrates how the radio daisy chain can also be deployed in an array topology. An 8×8 array with 64 radios is shown in this embodiment, with 16 daisy chains connected to a network switch (e.g. without limitation a PoE+ switch). Such an array can be used for many applications, including beamforming and MIMO.

FIG. 16 illustrates how Cloud-Radio Access Network (“C-RAN”) architecture can be used with radio daisy chains. In one embodiment, the baseband waveforms are computed in the Data Center Servers. They can serve a local network 1601 to the data center (e.g., without limitation, if the data center is in a stadium, and the local network is distributed throughout the stadium), connecting to a switch, which connects to multiple radio daisy chains.

Line of sight microwave 1602 can be used as a data link to go a farther distance than a local network, and it too can connect to a switch, which connects to multiple radio daisy chains.

Fiber 1603 can go a very long distance without a line of sight requirement and can connect to a switch, which connects to multiple radio daisy chains. Also, the switch can couple repeated fiber 1604 to another switch which then can connect another group of multiple radio daisy chains.

Although the illustration in FIG. 16 shows straight daisy chains, as noted previously, they can be bent into whichever shape is convenient and aesthetically pleasing.

The C-RAN topology illustrated in FIG. 16 supports the pCell™ MU-MAS system illustrated in FIGS. 1, 2 and 3 and in Related patents and applications. Unlike other wireless technologies, pCell supports extremely high density radio deployments, and is not dependent on a particular arrangement of radios or antennas (e.g. in contrast, cellular technology requires specific radio spacing in accordance with a cell plan). As such, pCell technology is highly suited for the daisy chain radio embodiments described herein, and is able to exploit radios that are placed where convenient and aesthetically pleasing.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices. Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

We claim:

1. A multiple antenna system (MAS) with multiuser (MU) transmissions (“MU-MAS”) comprising:
a plurality of 10 or more wireless transceiver devices distributed throughout a coverage area arranged in an electrical or optical fiber (collectively “Wireline”) daisy chain;
a plurality of wireless user devices (UEs) communicatively coupled to the one or more of the plurality of wireless transceiver devices; and
a processor to perform precoding to generate a plurality of waveforms for the plurality of wireless transceiver devices to transmit within a same frequency band,
wherein the waveforms interfere with one another to create a plurality of concurrent non-interfering downlink (DL) or uplink (UL) data links between the plurality of wireless transceiver devices and the plurality of UEs within the same frequency band.

2. The system as in claim 1 further comprising:
the plurality of concurrent non-interfering DL or UL data links utilizes a 3GPP standard wireless protocol.

3. The system as in claim 2 further comprising:
the 3GPP standard wireless protocol is an LTE protocol.

4. The system as in claim 2 further comprising:
the 3GPP standard wireless protocol is a 5G protocol.

5. The system as in claim 1 further comprising:
the plurality of waveforms communicably coupled from the processor to the plurality of wireless transceiver devices through the Wireline daisy chain.

6. The system as in claim 1 further comprising:
the plurality of wireless transceiver devices receive clock, pulse per second, Global Positioning Satellite or other timing information (collectively “Timing Information”) from signals carried on the Wireline daisy chain.

7. The system as in claim 1 further comprising:
the plurality of wireless transceiver devices receive Timing Information from signals external to the Wireline daisy chain.

8. The system as in claim 1 further comprising:
the plurality of wireless transceiver devices receive power from the Wireline daisy chain.

9. The system as in claim 1 further comprising:
the plurality of wireless transceiver devices receive power wirelessly.

10. The system as in claim 1 further comprising:
the Wireline daisy chain is enclosed within a tube.

11. A method implemented within a MU-MAS comprising:
arranging 10 or more wireless transceiver devices distributed throughout a coverage area in an electrical or optical fiber (collectively “Wireline”) daisy chain;
the plurality of wireless transceiver devices communicating to a plurality of UEs; and
precoding a plurality of waveforms for the plurality of wireless transceiver devices to transmit within a same frequency band wherein the waveforms interfere with one another to create a plurality of concurrent non-interfering DL or UL data links between the plurality of wireless transceiver devices and the plurality of UEs within the same frequency band.

12. The method as in claim 11 further comprising:
utilizing a 3GPP standard wireless protocol for communicating over the plurality of concurrent non-interfering DL or UL data links.

13. The method as in claim 12 further comprising:
the 3GPP standard wireless protocol is an LTE protocol.

14. The method as in claim 12 further comprising:
the 3GPP standard wireless protocol is a 5G protocol.

15. The method as in claim 11 further comprising:
communicating the plurality of waveforms to the plurality of wireless transceiver devices through the Wireline daisy chain.

16. The method as in claim 11 further comprising:
receiving by the plurality of wireless transceiver devices clock, pulse per second, Global Positioning Satellite or other timing information (collectively “Timing Information”) from signals carried on the Wireline daisy chain.

17. The method as in claim 11 further comprising:
receiving by the plurality of wireless transceiver devices Timing Information from signals external to the Wireline daisy chain.

18. The method as in claim 11 further comprising:
receiving power by the wireless transceiver devices from the Wireline daisy chains.

19. The system as in claim 11 further comprising:
receiving power wirelessly by the plurality of wireless transceiver devices.

20. The system as in claim 11 further comprising:
enclosing the Wireline daisy chain within a tube.
